(19) United States
(12) Patent Application Publication
(10) Pub. No.: US 2014/0244207 A1
(43) Pub. Date: Aug. 28, 2014

(54) METHODS AND APPARATUS TO DETERMINE IN-AISLE LOCATIONS IN MONITORED ENVIRONMENTS

(71) Applicant: Michael Alan Hicks, Clearwater, FL (US)

(72) Inventor: Michael Alan Hicks, Clearwater, FL (US)

(21) Appl. No.: 13/781,096

(22) Filed: Feb. 28, 2013

(51) Int. Cl. G01C 3/00

(52) U.S. Cl. CPC G01C 3/00
USPC 702/150

(57) ABSTRACT

Apparatus and methods to determine in-aisle locations in monitored environments are disclosed. An example apparatus includes first and second sensors in communication with a location meter. The first sensor is to detect (1) a first sequence of position indicators when the location meter is moving along an aisle of a monitored environment in a first direction, or (2) a second sequence of the position indicators when the location meter is moving along the aisle in a second direction opposite the first direction. The second sensor is to detect (1) the second sequence of position indicators when the location meter is moving along the aisle in the first direction, or (2) the first sequence of the position indicators when the location meter is moving along the aisle in the second direction. An in-aisle position of the location meter is to be determined based on the first and second sequences of position indicators.

### FIELD OF THE DISCLOSURE

The present disclosure relates generally to consumer monitoring and, more particularly, to methods and apparatus to determine in-aisle locations in monitored environments.

### BACKGROUND

Technologies to track locations of individuals and/or objects include satellite based Global Positioning System (GPS), mobile phone tracking systems based on signals from radio towers, radio frequency identification (RFID) tags, and inertia based navigation systems. Such technologies are implemented over different coverage areas from a global scale (e.g., GPS) down to particular establishments (e.g., inside a building or particular store).

### BRIEF DESCRIPTION OF THE DRAWINGS

FIG. 1A illustrates a plan view of an example monitored environment in which locations and/or positions of movable objects may be monitored in accordance with the teachings of this disclosure.

FIGS. 1B-1E illustrate example shelving systems of the example monitored environment of FIG. 1A having different example arrays of position indicators.

FIG. 2 is a perspective view of a portion of the example monitored environment of FIG. 1A that depicts an example shopping cart constructed in accordance with the teachings disclosed herein alongside an example shelving system of the example monitored environment of FIG. 1A.

FIG. 3 illustrates an example encoding scheme of another example shelving system of the example monitored environment of FIG. 1A.

FIG. 4 is an example apparatus constructed in accordance with the teachings disclosed herein to determine positions of shopping carts in the example monitored environment of FIG. 1A.

FIG. 5 is a flow diagram representative of example machine executable instructions which may be executed to implement the example apparatus of FIG. 4 to determine positions of shopping carts in the monitored environment of FIG. 1A.

FIG. 6 is a block diagram of an example processor platform capable of executing the instructions of FIG. 5 to implement the example apparatus of FIG. 4.

### DETAILED DESCRIPTION

Example methods, apparatus, and articles of manufacture disclosed herein may be used to determine locations in monitored environments. Prior systems for monitoring locations of people (e.g., shoppers, consumers, etc.) use different types of location-detection techniques. Many prior location-detection techniques have several drawbacks including influencing behaviors of monitored individuals. For example, persons knowing that their whereabouts are being monitored based on wearable/carriable electronic devices may alter their shopping habits to meet their expectations of how they would like to be perceived. Another drawback of prior location-detection techniques relates to using commercially available technologies to monitor persons' locations. While such commercially available technologies are readily available and popular among consumers, they have technical limitations that prevent collecting accurate data on a consistent basis. For example, location services (e.g., the Global Positioning System (GPS) service) often used with mobile devices in combination with mapping data and navigation software have, in some respects, changed the way people behave when outside the home. The ability to find addresses and, more specifically, retail locations has improved the efficiency and effectiveness of shopping activities. Radio frequency (RF) signals associated with the GPS service is significantly attenuated by walls and structures of buildings such as retail establishments (e.g., grocery stores, malls, etc.). Due to such signal attenuation, GPS-based navigation is unavailable or otherwise unreliable at indoor locations. Even if reception of RF-signals of an external location system (e.g., a system of towers for cellular communications) can be received within a building, they do not provide sufficient resolution to identify indoor locations of shoppers to sufficiently and accurately differentiate between different areas of a retail establishment. In addition, not all people are amenable to carry/own a mobile phone.

Other types of local RF-based location detection systems are sometimes used in indoor environments. Such locally installed, RF-based location systems have drawbacks associated with high installation and maintenance costs for retailers and lack of universality for the consumer. For example, specialized RF-based location systems do not have cross-platform compatibility to work with portable devices (e.g., cell phones, smart phones, tablets, etc.) already carried/owned by consumers. In some settings, inertia-based sensors (e.g., accelerometers, gyroscopes) are used to continuously calculate locations based on dead reckoning techniques. However, inertia-based dead-reckoning techniques suffer from accumulated error and can impose installation and maintenance costs and/or lack universality for consumers that do not carry/own a portable device with such inertia-based sensors.

Examples disclosed herein determine locations of shopping carts pushed by consumers or shoppers in a monitored environment. For convenience of explanation, examples disclosed herein are described with reference to shopping carts pushed by shoppers. However, the teachings disclosed herein can be used in connection with other types of individuals pushing or otherwise operating other types of vehicles that facilitate that carrying of products (e.g., forklifts, dollies, flat bed carts, motorized shopping carts, etc.). Furthermore, monitored environments in which the teachings disclosed herein may be implemented include any environment composed of aisles such as stores (e.g., grocery stores, department stores, club stores, clothing stores, specialty stores, hardware stores, retail establishments, etc.) or commercial establishments (e.g., wholesalers, warehouses, trade show venues, etc.). In some examples, location information is used to show shoppers real-time displays of their current location on a map and/or to provide shoppers with in-store directions to products and/or other in-store locations. Disclosed examples use pattern-encoded labels or plates stationarily (fixedly) located along aisles and readable by sensors mounted on shopping carts. As a shopping cart moves along an aisle, its sensors read the pattern-encoded labels along the aisle to determine its positions or locations in the aisle. That is, the pattern-encoded labels encode location/position information corresponding to the in-store location or in-aisle location at which they are located. Some disclosed examples use light sources and corresponding light sensors (e.g., photodetectors) to read the pattern-encoded labels. In some examples, the sensors are implemented using infrared (IR) light. In some examples, accelerometers, gyroscopes, compasses, and/or other motion sensing and position sensing devices are also used to provide a secondary measurement to validate the in-aisle position of the shopping cart determined via the sensors. In some examples, two light sources are positioned on the shopping cart in opposing directions to transmit light toward the shelving units on either side of an aisle in directions substantially perpendicular to a direction of travel of the shopping cart. In such examples, the light is either reflected or absorbed by corresponding light-reflective or light-absorbing indicia arranged on the pattern-encoded labels along each shelving unit. In some examples, the light is transmitted and/or reflected diffusively (e.g., ambient light). In other examples, a narrow beam of light (e.g., a laser) is transmitted to and reflected from the pattern-encoded labels.

A pattern of binary feedback from each side of the corresponding aisle may be analyzed to determine location information. For example, the reflectance and non-reflectance of light at different portions of the pattern-encoded labels form binary information as the sequence of the reflective and non-reflective portions are detected. The sequences of light-reflecting and light-absorbing indicia of each pattern on either side of each aisle in a store are unique with respect to the sequences in other aisles such that when analyzed, the position of the shopping cart is determined with a relatively high level of accuracy. In particular, the in-aisle position or location of the shopping cart is specified using three parameters determined by analyzing, in combination, the patterns on both sides of the aisle in which the shopping cart is situated. The parameters that specify an in-aisle position include (1) an aisle identifier (e.g., an aisle number), (2) a location within the aisle (e.g., distance traveled from a point of entry into the aisle or distance remaining to a reference end of an aisle), and (3) a direction of travel or movement (e.g., an orientation of the shopping cart with respect to a reference (e.g., a cardinal direction, a front of the store, etc.)). Using the detected information, a map of the store can be generated to display the location of the shopping cart and/or instructions providing directions to other products and/or other in-store locations (e.g., the restroom, a particular department, nearest checkout, etc.) requested by the shopper pushing the shopping cart.

Methods and apparatus to determine in-aisle locations in monitored environments are disclosed. Disclosed example apparatus include first and second sensors in communication with a location meter. In some such examples, the first sensor is oriented toward a first side of the apparatus to detect (1) a first sequence of position indicators in a first array of the position indicators when the location meter is moving along an aisle of a monitored environment in a first direction, or (2) a second sequence of the position indicators in a second array of the position indicators when the location meter is moving along the aisle in a second direction opposite the first direction. In some such examples, the first and second directions are substantially parallel with a length of the aisle. In some such examples, the second sensor is to detect (1) the second sequence of position indicators when the location meter is moving along the aisle in the first direction, or (2) the first sequence of the position indicators when the location meter is moving along the aisle in the second direction. In such examples, an in-aisle position of the location meter is to be determined based on the first and second sequences of position indicators.

Disclosed example methods involve detecting a first sequence of position indicators in a first array of position indicators. The first sequence in some examples is detected by (1) a first sensor in communication with a location meter when the location meter is moving in a first direction along an aisle, or (2) a second sensor in communication with the location meter when the location meter is moving along the aisle in a second direction opposite the first direction. Some such example methods further include detecting a second sequence of position indicators in a second array of position indicators. In such examples, the second sequence is detected by (1) the first sensor when the location meter is moving in the second direction along the aisle, or (2) the second sensor when the location meter is moving in the first direction along the aisle. Some example methods also include determining an in-aisle position of the location meter based on the first and second sequences.

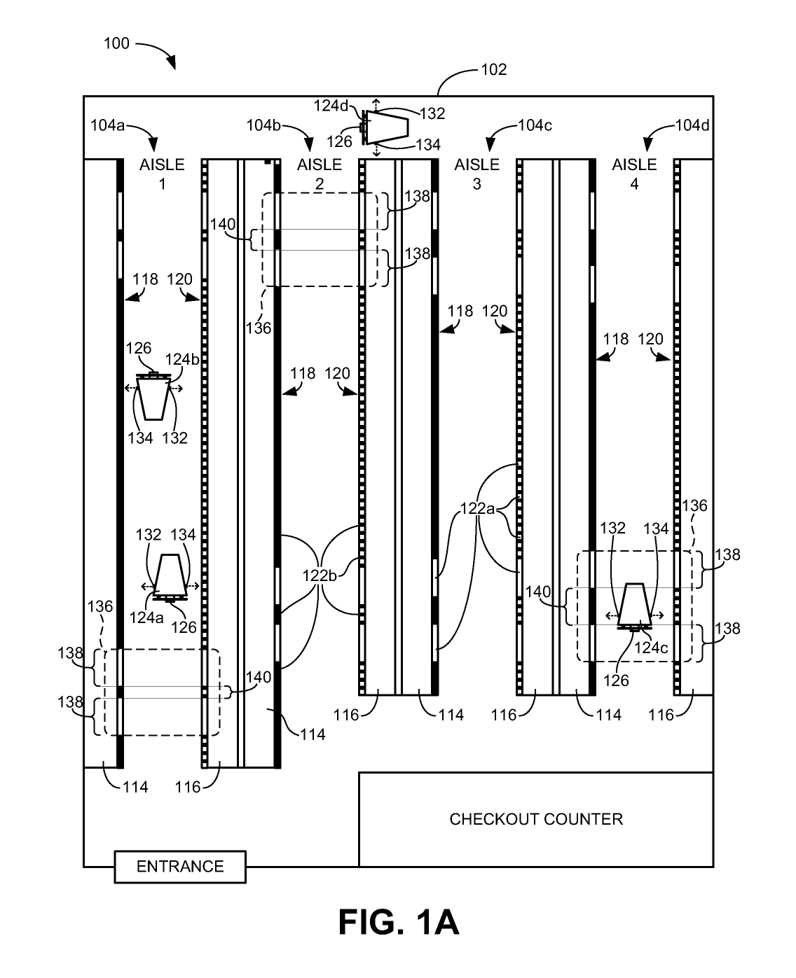

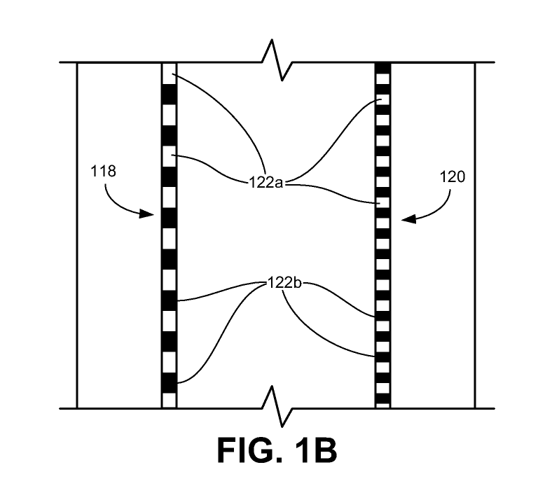

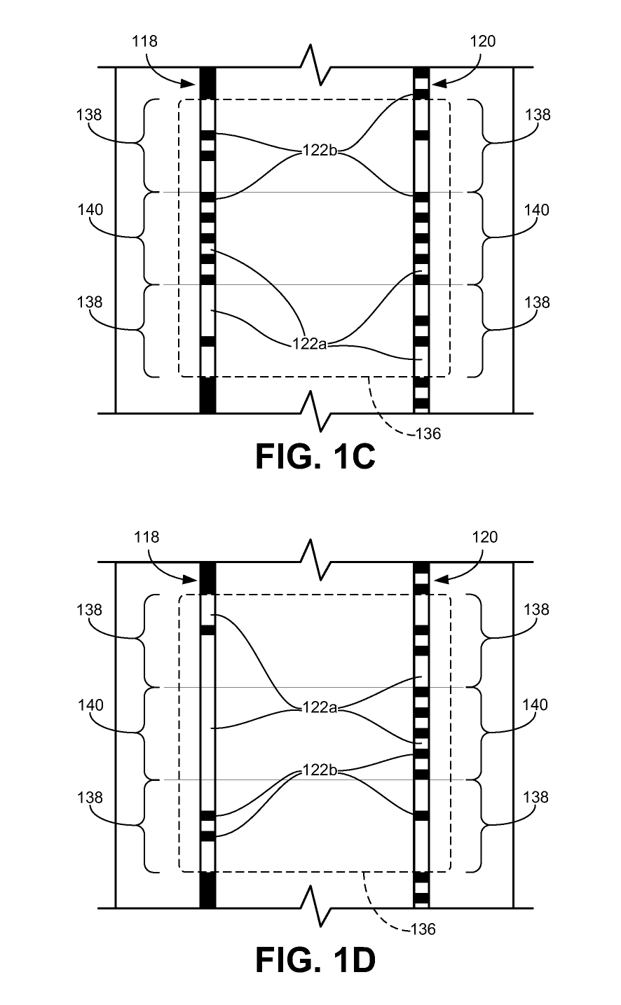

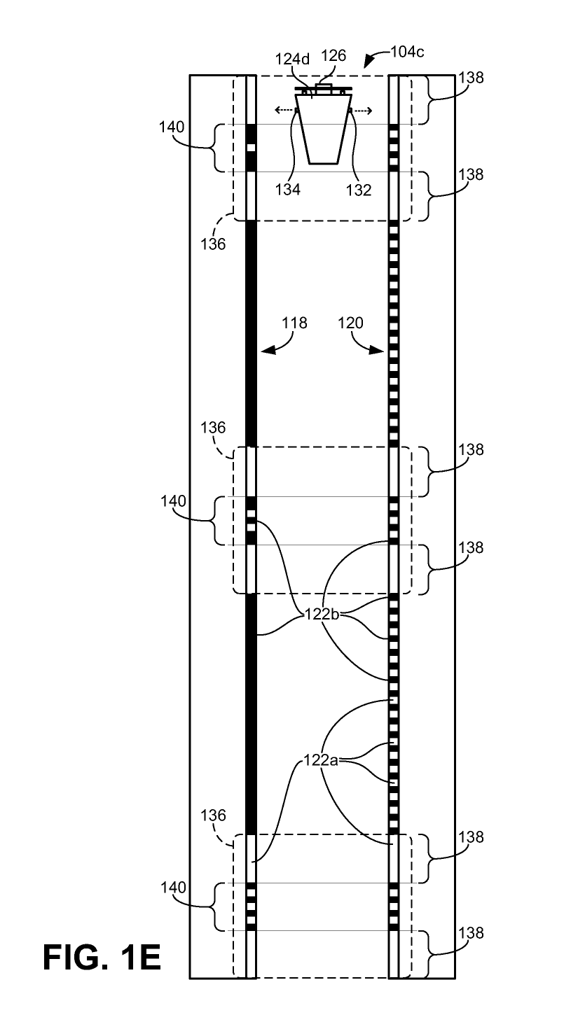

FIG. 1A shows a layout 100 of an example monitored environment 102 having aisles 104a-d that can be used to implement examples disclosed herein. As described above, the teachings disclosed herein can be used in connection with any type of environment such as stores (e.g., grocery stores, department stores, clothing stores, specialty stores, hardware stores, retail establishments, etc.) or commercial establishments (e.g., warehouses, wholesalers, trade show venues, etc.) that have aisles along which shopping carts or other vehicles to facilitate carrying products (e.g., forklifts, dollies, flat bed carts, motorized shopping carts, etc.) may travel. In the illustrated example, each aisle 104a-d is defined by a shelving system 114 on a primary side of each aisle 104a-d and a shelving system 116 on the opposing side (a secondary side) of each aisle 104a-d. As used herein, the labels “primary” and “secondary” for the sides of the aisles 104a-d do not hold any particular meaning other than distinguishing one side of the aisle 104a-d from the other with respect to a common reference. For example, as shown in the illustrated example, each shelving system 114 of each aisle 104a-d is on the same side of the aisle 104a-d (e.g., the left side of each aisle 104a-d as illustrated in FIG. 1A and/or when viewed from the entrance of the environment 102), which for purposes of explanation is referred to herein as the “primary” side. As also shown in FIG. 1A, the shelving system 116 of each aisle 104a-d is on the same side of the aisle 104a-d opposite the primary side, which for purposes of explanation is referred to herein as the “secondary” side. That is, the “primary” side of the aisle 104a, as shown in FIG. 1A, is on the same side as the “primary” side of each of the other aisles 104b-d. In addition, although the shelving systems 114, 116 form the aisles 104a-d in FIG. 1A, in some examples, the aisles 104a-d are formed by other types of product display systems (e.g., bins, tables, walls, stands, racks, refrigerators, freezers, etc.). In the illustrated example, each aisle 104a-d includes position arrays 118, 120 of position indicators 122a-b extending along the length of the aisles 104a-d along each longitudinal side (e.g., the primary side and the opposing secondary side). In the illustrated example, the array 118 is on the primary side of the aisles 104a-d, and the array 120 is on the secondary side of the aisles 104a-d. In some examples, the arrays 118, 120 of position indicators 122a-b are printed on labels or plates and affixed along lengths of corresponding shelving systems 114, 116. Each array 118, 120 in the illustrated example has a sequence of position indicators 122a-b that encodes location information for different locations of the corresponding aisles 104a-d. The position indicators 122a-b of the illustrated example have a distinguishing characteristic (e.g., color, reflectivity, etc.) that enables each position indicator 122a-b to be identified as being associated with a first category of position indicators (e.g., illustrated by the white position indicators 122a) or a second category of position indicators (e.g., illustrated by the black position indicators 122b). In the illustrated example, the position indicators 122a are light reflecting, and the position indicators 122b are non-reflective or light absorbing. In some examples, the arrays 118, 120 are formed from a single aisle-length label or plate that attaches to the shelving systems 114, 116, and the position indicators 122a-b encode location information indicative of specific positions of the label plate. In other examples, each position indicator 122a-b is a separately applied label or plate such that some labels or plates are completely light-reflecting and others are completely light-absorbing so that locating these adjacent one another in different combinations encodes different location or position information. In other examples, the position indicators 122a-b are painted on the shelving systems 114, 116 to encode different position or location information corresponding to the different portions of the aisle. In some examples, where the shelving systems 114, 116 are already light-absorbing such that only the light-reflecting position indicators 122a are added to encode position or location information using the light-absorbing background color of the shelving systems 114, 116 and overlaid combinations of light-reflecting position indicators 122a. Additionally or alternatively, any other suitable method of making different sequences of light-reflecting and light-absorbing surfaces on the shelving systems 114, 116 may be used. In other examples, light sources (e.g., light-emitting diodes (LEDs)) may be used in place of the light-reflecting position indicators 122a to directly produce light instead of reflect light to encode position or location information based on different patterns of light sources and gaps between the light sources (corresponding to the light-absorbing position indicators 122b).

Also shown in the illustrated example of FIG. 1A are shopping carts 124a-d having sensing apparatus constructed in accordance with the teachings of this disclosure. The shopping carts 124a-d are located at various locations throughout the monitored environment 102 as they are pushed by shoppers. In the illustrated example, each shopping cart 124a-d has a location meter 126 in communication with two sensors 132, 134 on opposing sides of each shopping cart 124a-d (e.g., on corresponding left and right sides perpendicular to a direction of travel of the shopping cart). In the illustrated example, the sensors 132, 134 include photodetectors to detect reflections or non-reflections of light from the position indicators 122a-b as the shopping cart 124a-d is pushed along one of the aisles 104a-d. In some examples, the shopping carts 124a-d are also provided with light sources such as IR transmitters, and the sensors 132, 134 are IR receivers. In this manner, the sensors 132, 134 can detect the position indicators 122a-b even if sufficient ambient light is not available to reflect from the position indicators 122a-b at levels detectable by the sensors 132, 134. However, other sensors using different wavelengths of light (e.g., visible light) may alternatively be used. In other examples, the sensors 132, 134 operate without corresponding light sources, and rely on ambient light. In other examples, the arrays 118, 120 are alternatively provided with light emitters (e.g., LEDs) in place of the light-reflecting position indicators 122a to produce light that is detected by the sensors 132, 134. In examples in which light sources are mounted to the carts 124a-d, they are positioned to emit light from opposite sides of the shopping cart 124a-d toward the arrays 118, 120 of position indicators 122a-b on the facing shelving systems 114, 116. The sensors 132, 134 in the illustrated example are positioned to detect the transmitted light when it is reflected (illustrated by the dotted arrows) back off the light-reflecting indicators 122a associated with the patterns 118, 120 facing the corresponding sensors 132, 134. In this manner, the location meter 126 receives two sequences of binary feedback signals that may be detected by the sensors 132, 134 on the shopping carts 124a-d based on the pattern of position indicators 122a-b correspondingly located on facing arrays 118, 120 within any one of the aisles 104a-d. In other words, at any point in time and for any location within the environment 102, the location meter 126 will identify one of four possible combined feedback signals from the sensors 132, 134 corresponding to a two-bit binary feedback: (1) no feedback signal (i.e., no reflected light) detected by either sensor 132, 134, (2) no feedback signal from the sensor 132 and a feedback signal from the sensor 134, (3) a feedback signal from the sensor 132 but no feedback signal from the sensor 134, or (4) feedback signals from both sensors 132, 134. Accordingly, as the shopping cart 124a-d is moved along any of the aisles 104a-d, the sensors 132, 134 can identify location or position information based on reading encoded information based on different sequences of the position indicators 122a-b in the facing arrays 118, 120 identified on either side of the shopping cart 124a-d substantially simultaneously.

In the illustrated example of FIG. 1A, the arrays 118, 120 in each aisle 104a-d are unique with respect to the arrays 118, 120 in every other aisle 104a-d. In some examples, the sequence of position indicators 122a-b of each array 118, 120 may include segments of successive (e.g., two or more) light-reflecting position indicators 122a, segments of successive (e.g., two or more) light-absorbing position indicators 122b, and/or segments of alternating reflective and absorptive position indicators 122a-b. In some examples, the beginning and end of successive light-reflecting or light-absorbing position indicators 122a-b are not detectable. Thus, the successive position indicators 122a-b having the same reflective characteristics could be described as a single reflective or non-reflective position indicator 122a-b with a greater width than other position indicators. However, for simplicity in explanation, the longer sections of reflective or non-reflecting segments in each array 118, 120 are described herein as a series of successive position indicators 122a-b. Due to the various combinations in which the corresponding position indicators 122a-b (e.g., position indicators 122a-b on the array 118 facing position indicators 122a-b on the array 120) may be arranged, as will be described in greater detail below, in some examples, as the shopping cart 124a-d moves along one of the aisles 104a-d, the resulting patterns of the two binary feedback signals detected by the sensors 132, 134 is uniquely designed to determine the positions of the shopping carts 124a-d within the monitored environment 102. In particular, in some examples, the location meter 126 records and analyzes the unique pattern of position indicators 122a-b arranged in facing arrays 118, 120 to identify the orientation or direction of travel of the shopping cart 124a-d, the particular aisle 104a-d where the corresponding shopping cart 124a-d is located, and the distance traveled within the aisle (e.g., relative to one of the ends of the aisle).

In the illustrated example, the directions of travel of the shopping carts 124a-d are determined based on which of the sensors 132, 134 is facing which array 118, 120. In the illustrated example of FIG. 1A, the arrays 118 associated with the primary side of each aisle 104a-d comprise long segments of light-absorbing position indicators 122b. In contrast, the arrays 120 associated with the primary side of each aisle 104a-d comprise corresponding segments of alternating position indicators 122a-b (e.g., alternating between light-absorbing and light-reflecting). By comparing the sequence of the feedback signals received from each of the segments as they are substantially simultaneously detected by the corresponding sensors 132, 134, the arrays 118, 120 can be distinguished and the directions of travel of the shopping carts 124a-d determined.

For example, the shopping cart 124a is oriented in the first aisle 104a such that the left sensor 132 is facing the primary side of the aisle 104a (e.g., shelving system 114). As such, when the shopping cart 124a is pushed forward by a shopper, the left sensor 132 will not detect any light because the array 118 on the primary side of the aisle 104a is composed of successive light-absorbing position indicators 122b (or a single extended light-absorbing position indicator 122b). However, as the shopping cart 124a is pushed forward, the right sensor 134 will detect an alternating feedback signal (e.g., alternating instances of reflecting light and non-reflection of light) corresponding to the alternating reflective and absorptive position indicators 122a-b of the array 120 on the secondary side of the aisle 104a (e.g., shelving system 116). In contrast, the shopping cart 124b is oriented in the illustrated example such that the sensors 132, 134 are facing opposite directions relative to the sensors 132, 134 of the shopping cart 124a. Accordingly, as the shopping cart 124b is pushed forward along the aisle 104a in a direction opposite a direction of travel of the shopping cart 124a, the left sensor 132 will detect the alternating feedback signal from the array 120 while the right sensor 134 will not detect any feedback light because of the non-reflecting position indicators 122b of the array 118. Thus, the direction of travel of the shopping carts 124a, 124b can be determined in the illustrated example based on which of the sensors 132, 134 detects the corresponding arrays 118, 120 on opposing sides of the aisle 104a. In the illustrated example, this same analysis applies to all of the aisles 104a-d because they each have a similar arrangement of opposite-facing arrays 118, 120 along each side of aisles 104a-d (e.g., the primary side of each aisle 104a-d is always on the same side relative to each other, the front of the store, and/or any other common reference point). In some examples, the facing arrays 118, 120 may be arranged in reverse (e.g., the alternating pattern on primary sides of the aisles 104a-d). In other examples, any other suitable arrangement of the position indicators 122a-b on one or both sides of the aisles 104a-d may be implemented to identify directions of travel so long as the facing arrays 118, 120 can be distinguished by the resulting patterns detected by the sensors 132, 134 of the shopping carts 124a-d as the shopping carts 124a-d move along each aisle 104a-d. For example, the shelving system 116 on the secondary side may comprise an alternating sequence of reflective and absorptive position indicators as shown in FIG. 1A while the shelving systems 114 primary side of the aisles 104a-d may comprise a repeating pattern of two successive light-reflecting position indicators 122a followed by two successive light-absorbing position indicators 122b (e.g., as illustrated in FIG. 1B). In this manner, as a shopping cart 124a-d moves along one of the aisles 104a-d, the sensor 132, 134 facing the primary side of the aisle 104a-d will detect one feedback signal for every two feedback signals detected by the sensor 132, 134 facing the secondary side of the aisle 104a-d such that each side of the aisle 104a-d may be distinguished from the other to determine the direction of movement of the shopping cart 124a-d. In a similar manner, any other suitable pattern may be implemented on each of the arrays 118, 120 to distinguish each side of the aisles 104a-d.

In some examples, the environment 102 may have aisles 104a-d that are not all parallel to one another (e.g., some aisles may be parallel to each other as shown in FIG. 1A while one or more additional aisles may be perpendicular or at some other angle relative to other aisles). In such examples, the “primary” side of each aisle will not always be on the same side with respect to a common reference because the aisles are not all oriented the same way. However, in some such examples, each of the aisles still has distinguishable sides with corresponding arrays 118, 120 that are known so that the direction of travel of the shopping carts 124a-d can be determined as described above once the particular aisle is identified (and, thus, the orientation of the aisle is known) To determine the particular aisle 104a-d where each shopping cart 124a-d is located, in some examples, each set of facing arrays 118, 120 include one or more aisle identification sections 136. In some examples, each aisle identification section 136 includes first and second boundary portions 138 to demarcate central identifier portions 140 of the arrays 118, 120. In the illustrated example, the boundary portions 138 are segments of successive light-reflecting position indicators 122a (shown as a single extended white segment). Accordingly, as shown in the illustrated example, as the shopping cart 124c passes through one of the boundary portions 138, both sensors 132, 134 will detect a corresponding feedback signal reflected off of the position indicators 122a of the corresponding boundary portion 138. In the illustrated example, detecting the light on both sides of the shopping cart 124c is an indication that the shopping cart 124c is about to move passed the identifier portion 140 of the aisle identification sections 136. As the shopping cart 124c of the illustrated example continues to move forward, the sensors 132, 134 will similarly detect the second boundary portion 138 indicating the identifier portion 140 has ended.

The illustrated example of FIG. 1A shows example boundary portions 138 of the aisle identification section 136. However, other sequences or combinations of the position indicators 122a-b may alternatively be implemented in the boundary portions 138 to distinguish or delineate the aisle identification section 136 from the rest of the arrays 118, 120 and, more particularly, indicate a beginning and ending of the identifier portion 140. For example, the sequences of the position indicators 122a-b in the boundary portion 138 at one end of the aisle identification section 136 may be any suitable pattern that is rotationally symmetric (e.g., rotated by 180 degrees) to the boundary portion 138 at the opposite end of the aisle identification section 136 (an example of which is shown in FIG. 1C). In such examples, the sensors 132, 134 will detect the same combined sequence or pattern of position indicators 122a-b regardless of the direction from which the shopping cart 124a-d approaches the corresponding aisle identification section 136. Furthermore, in the example of FIG. 1C, the sensors 132, 134 will detect the same combined sequence of position indicators 122a-b upon entering the either boundary portion 138 from the identifier portion 140 regardless of the direction of travel. However, whether a shopping cart 124a-d is entering the aisle identification section 136 or transitioning from the identifier portion 140 to the boundary portion 138 within the aisle identification section 136 can be determined. For example, in FIG. 1C, both sensors 132, 134 detecting a non-reflective position indicator 122b substantially simultaneously on each side of the aisle followed by a single non-reflective position indicator 122b on one side of the aisle is indicative of entering the aisle identification sections 136. In contrast, if the sensors 132, 134 detect a single non-reflective position indicator 122b on one side followed by non-reflective position indicators 122b detected substantially simultaneously on each side of the aisle, the location meter 126 can determine that the shopping cart 124a-d is leaving the identifier portion 140 and passing through one of the boundary portions 138. Additionally, the rotationally symmetric boundary portions 138 of the illustrated example also enable the location meter 126 to determine whether the shopping cart 124a-d is moving backwards. For example, after a shopping cart 124a-d leaves the identifier portion 140 of the aisle identification section 136 while moving forward, the single non-reflective position indicator 122b will be detected by the left sensor 132 regardless of the direction. Thus, if a shopping cart 124a-d is moving backwards, the single non-reflective position indicator 122b will be detected by the right sensor 134, thereby indicating the shopping cart 124a-d is moving backwards.

Additionally or alternatively, other sequences of the position indicators 122a-b in the boundary portions 138 may be implemented to indicate similar position information as described above with the rotationally symmetric boundary portions 138. For instance, in the illustrated example of FIG. 1D, the boundary portions 138 on either end of the aisle identification section 136 are symmetrical across a line down the middle of the aisle (e.g., the boundary portions 138 are mirror images of each other). In such examples, the direction of travel of a shopping cart 124a-d may be determined based upon the order in which the single non-reflective position indicator 122b on one side is detected relative to the corresponding pair of non-reflective position indicators 122b on opposite sides of the aisle are detected within each boundary portion 138. Additionally, whether the pair of non-reflective position indicators 122b are detected first or the single non-reflective position indicator 122b is detected first also indicates the aisle end from which the shopping cart 124a-d approached the aisle identification section 136. Based on this information, in connection with the sensor 132, 134 that detect the single non-reflective position indicator 122b, the location meter 126 may determine whether the shopping cart 124a-d is moving backwards. In yet other examples, other combinations and/or sequences of the position indicators 122a-b in the boundary portions 138 are arranged to indicate similar position information.

The identifier portion 140 of the aisle identification sections 136 in the illustrated example of FIG. 1A includes a segment where at least one side of the aisle contains a series of alternating reflective and absorptive position indicators 122a-b (e.g., the identifier portion 140 on the secondary side of the aisles 104a-d as shown in FIG. 1A). In some examples, the number of reflecting position indicators 122a in the identifier portion 140 corresponds to an aisle identifier (e.g., an aisle number) associated with the corresponding aisle. Thus, as shown in the illustrated example of FIG. 1A, the first aisle 104a (e.g., aisle 1) has one light-reflecting position indicator 122a in the identifier portion 140, the second aisle 104b (e.g., aisle 2) has two light-reflecting position indicators 122a in the identifier portion 140, the third aisle 104c (e.g., aisle 3) has three light-reflecting position indicators 122a in the identifier portion 140, and the fourth aisle 104d (e.g., aisle 4) has four light-reflecting position indicators 122a in the identifier portion 140.

As the aisle identifier is identifiable by using only one array 118, 120 on one side of the corresponding aisle 104a-d, the sequence of position indicators 122a-b in the identifier portion 140 on the other side of the corresponding aisle 104a-d is not used in the illustrated example to determine the particular aisle. However, in the illustrated example, the identifier portion 140 on the second side (e.g., on the array 118 in FIG. 1A) of each aisle 104a-d includes successive light-absorbing position indicators 122b to correspond with the arrangement of the position indicators 122b outside of the aisle identification sections 136 along the rest of the corresponding array 118. In some examples, the identifier portion 140 on the second side of each aisle includes successive light-absorbing position indicators 122b to distinguish the identifier portion 140 of each aisle identification section 136 from the rest of the arrays 118, 120 (e.g., FIG. 1D). In other examples, the identifier portion 140 is the same on both sides of the aisle 104a-d to provide redundancy in case something (e.g., a floor display, a product, a customer, another shopping cart 124a-d, etc.) is obstructing the light from shining upon and/or reflecting back off any portion of the identifier portion 140 on one of the sides (e.g., FIG. 1C). In yet other examples, other sequences or combinations of the position indicators 122a-b may be used. Additionally or alternatively, as shown in FIG. 1A, each aisle 104a-d can include more than one aisle identification section 136 to provide redundancy and/or to account for shopping carts 124a-d entering from either end of the aisles 104a-d.

In connection with identifying the direction of travel (orientation) of each shopping cart 124a-d and the particular aisle 104a-d where each shopping cart 124a-d is located, the distance traveled by each shopping cart 124a-d within the identified aisle 104a-d provides a third parameter to accurately identify the position of each shopping cart 124a-d within the monitored environment 102. In the illustrated example, a measurement of the distance traveled at any point along one of the aisles 104a-d is determined based on a known width for each of the position indicators 122a-b and based on counting the total number of position indicators 122a-b passed by the shopping carts 124a-d after entering one of the aisles 104a-d. In such examples, the total number of position indicators 122a-b is determined by counting the number of reflected feedback signals the sensor 132, 134 facing the secondary side of the aisles 104a-d detects from the alternating sequence of reflective and absorptive position indicators 122a-b on the corresponding array 120. This number is then multiplied by two (as each feedback signal indicates the shopping cart 124a-d has passed both a light-absorbing and a light-reflecting position indicator 122a) and multiplied by the known width of the position indicators 122a-b. For example, if each position indicator 122a-b has a width of six inches, then each light-reflecting position indicator 122a in the alternating arrays 120 is spaced apart by one foot (six inches for the reflective position indicator 122a plus six inches for the absorptive position indicator 122b). In such an example, if ten feedback signals (e.g., ten instances of light reflected back from ten light-reflecting position indicators 122a separated by ten light-absorbing position indicators 122b) are received by the sensor 132, 134 facing the array 118 as the shopping cart 124a-d moves along an aisle 104a-d from the time the shopping cart 124a-d first entered the corresponding aisle 104a-d, a calculation can be used to determine that the shopping cart 124a-d is ten feet into the aisle 104a-d based on multiplying ten (i.e., the quantity of feedback signals) by one foot (i.e., the length between reflective indicators 122a when each position indicator 122a-b is six inches in length).

As shown in FIG. 1A and as described above, the aisle identification sections 136 of each aisle 104a-d are demarcated by a series of successive light-reflecting position indicators 122a in the boundary portions 138. As such, when the shopping cart 124a-d passes through the boundary portion 138, there will not be an alternating feedback signal to count the position indicators 122a. Accordingly, to track the distance travelled by the shopping carts 124a-d in these sections of each aisle 104a-d, in the illustrated example, each boundary portion 138 is the same width. In this manner, once the shopping carts 124a-d have passed through one of the boundary portions 138, the calculated distance travelled is updated by adding the known width of the boundary portion 138 and then counting the alternating feedback signals of the identifier portion 140 to continue tracking the distance travelled as described above. For example, in FIG. 1A, there are four light-reflecting position indicators 122a on the ends of each aisle 104a-d before the aisle identification section 136 occurs such that, with the example of each position indicator 122a-b being six inches wide, the shopping cart 124a-d is four feet into the aisle 104a-d when it enters the aisle identification section 136.

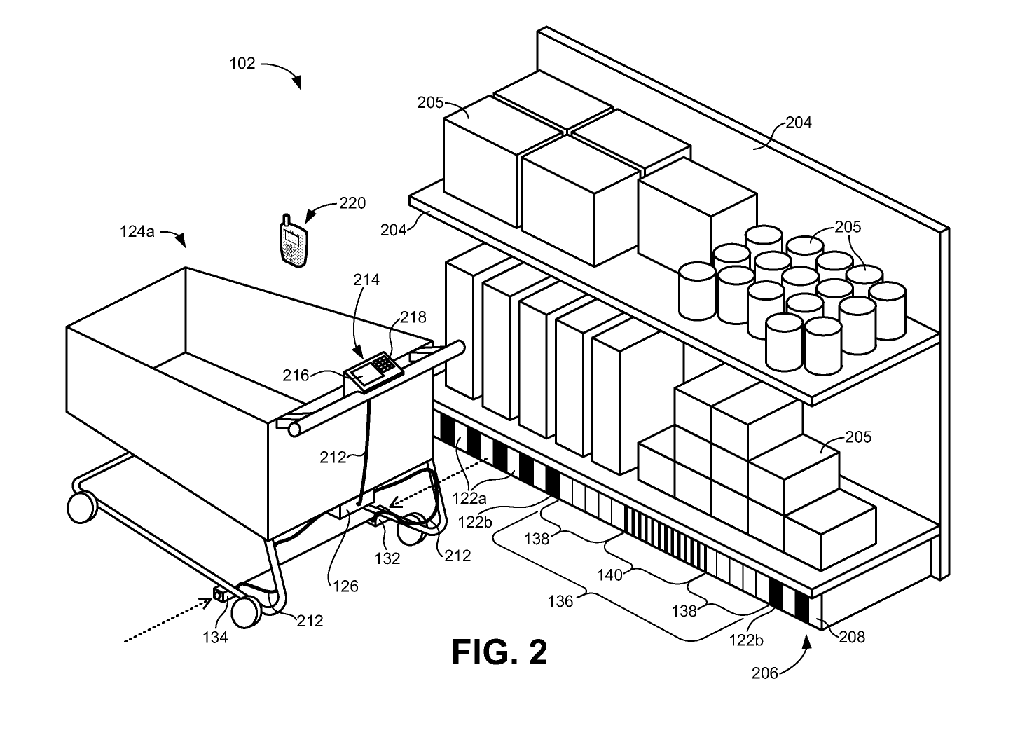

Further, in the illustrated example, the boundary portions 138 are nine position indicators 122a-b wide, or four and a half feet long. Thus, once the shopping cart 124a-d reaches the identifier portion 140 of the aisle identification portion 136, the width of the boundary portion 138 is added to the calculated distance to place the shopping cart 124a-d at nine and a half feet into the aisle 104a-d. In some examples, the known width of each boundary portion 138 includes the width of an extra position indicator 122a-b to account for the light-absorbing position indicator 122b separating the boundary portion 138 from the first light-reflecting position indicator 122a in the identifier portion 140 of the aisle identification section 136. In other examples, rather than defining a known width for the boundary portions 138 for each aisle identification section 136, the total width of each aisle identification section 136 may have a defined width with different lengths of the boundary portions 138 in each aisle 104a-d depending upon the widths of the corresponding identifier portions 140. In yet other examples, both the boundary portions 138 and the identifier portion 140 have fixed or known widths. In some such examples, the individual reflective and absorptive position indicators 122b in the identifier portion 140 vary in width between the different aisles 104a-d to fit within the predefined width of the identifier portion 140. In such examples, the widths of the position indicators 122a-b within the identifier portion 140 do not need to be constant or known (for purposes of counting feedback signals to track the distance travelled) because the total width of the identifier portion 140 is known and can be added to the calculated distance travelled as described above for the boundary portions 138. In this manner, the aisle identification sections 136 can be limited to a relatively isolated area regardless of the aisle number to be identified, as is described in greater detail below in connection with FIG. 2.

Using the above concepts of identifying an aisle 104a-d along which a shopping cart 124a-d is moving, determining the direction of movement, and the distance traveled into the aisle, the position of a shopping cart within a store may be determined. For example, the directions of travel may be used to identify whether the shopping carts 124a-d entered the aisles 104a-d from the first end or the second end relative to a reference point (e.g., based on cardinal directions (north end/south end), a store reference (end closest the entrance/furthest the entrance), etc.). Based on such a determination, the distance traveled from that end may then be used to pin point the location of each shopping cart 124a-d along the length of the appropriate aisle 104a-d as identified when the shopping carts 124a-d pass through one of the aisle identification sections 136. Furthermore, using this information the position of each shopping cart 124a-d may be tracked for marketing and sales purposes and/or to provide a map of the current location of the shopper pushing the shopping cart and/or directions to products and/or other locations within the store. Methods to implement these uses of the position information are known in the art and are, therefore, not described in detail herein.

Although the above explanation provides the general concepts to determine locations or positions of a shopping cart within a monitored environment, several additional details and examples are disclosed herein that may be used to overcome certain challenges to reduce and/or eliminate errors. In the illustrated example of FIG. 1A, opposing ends (e.g., entry ways and exits) of the aisles 104a-d are identified based on feedback signal comparisons during periods in which at least one of the sensors 132, 134 is receiving feedback signals (i.e., the shopping cart 124a-d is passing reflective position indicators 122a) and periods in which neither sensor 132, 134 is receiving feedback signals. For example, each of the shopping carts 124a-c is shown in FIG. 1A within at least one of the aisles 104a-d such that the location meter 126 will periodically receive feedback signals from the alternating arrays 120 on the primary side of each aisle 104a-d and/or from both of the arrays 118, 120 while moving through the aisle identification sections 136. In the illustrated example, the shopping cart 124d is not in any of the aisles 104a-d and, thus, the corresponding location meter 126 will not receive any feedback signals until the shopping cart 124d is moved into one of the aisles 104a-d. As the shopping carts 124a-c leave corresponding aisles 104a, 104d, or as the shopping cart 124d enters one of the aisles 104a-d, the change in whether the sensors 132, 134 continue detecting feedback signals indicates whether the shopping carts 124a-d have entered or left one of the aisles 104a-d. The challenge with this approach is that within each aisle 104a-d there are numerous points where both sensors 132, 134 will not detect any feedback, such as when one or both of the sensors 132, 134 are directed toward light-absorbing position indicators 122b on each side of the corresponding aisle 104a-d and/or when a light-reflecting indicator 122a is obstructed from the field of view of the sensors 132, 134 (e.g., by a product, a floor display, a shopper, another shopping cart, etc.). In some examples, the duration between successive feedback signals is timed such that regularly occurring signals indicate the shopping cart 124a-d is moving along an aisle, whereas an extended period without a feedback signal indicates the shopping cart 124a-d is not in an aisle.

However, shoppers do not push shopping carts 124a-d at a consistent speed, and shoppers frequently stop the carts to gather items for purchase and/or to look at store displays potentially resulting in the location meter 126 incorrectly interpreting the feedback signals. In some examples, this problem is resolved with a motion sensor that determines when each shopping cart 124a-d is moving and/or how fast it is moving. In other examples, to avoid the cost of additional components, each array 118, 120 includes an entry identification section at each end that functions similar to the aisle identification sections 136 described above. In some examples, the aisle identification sections 136 are located at the extremities of the aisles 104a-d such that the outer most boundary portions 138 serve as entry identification sections. For example, in the illustrated example of FIG. 1E, the shopping cart 124d is shown just after entering the third aisle 104c of the monitored environment 102 of FIG. 1A. In the example of FIG. 1E, the aisle 104c is shown having different arrays 118, 120 with aisle identification sections 136 at either end. In such an example, prior to entering the aisle 104c, both sensors 132, 134 of the shopping cart 124d detects an absence of a feedback signal because the shopping cart 124d is not in an aisle where the reflective position indicators 122a are located. However, upon entering the aisle 104c, as shown in FIG. 1E, both sensors detect feedback signals (e.g., reflective position indicators 122a are on both sides of the shopping cart 130). In some such examples, the transition from detecting the absence of a feedback signal to detecting the presence of feedback signals on both sides of the shopping cart 124d is indicative of entering an aisle (e.g., the aisle 104c). In some examples, the status of the shopping cart 124d being in an aisle is stored until the sensors 132, 134 detect the shopping cart 124d has move passed a known number of aisle identification sections 136 and/or detect the reverse transition of both sensors 132, 134 detecting feedback signals followed by both detecting no feedback indicating the shopping cart 124d has left the aisle 104c. In this manner, an in-aisle status of the shopping cart 124d can be determined even if the shopping cart 124d stops in the middle of the aisle 104c at a location where the sensors 132, 134 are both directed to a light-absorbing position indicator 122b (e.g., neither sensor is detecting any feedback). Similarly, if one of the sensors 132, 134 happens to detect light when not in an aisle (e.g., a random surface reflects the light from one of the sensors 132, 134 and/or light from another passing shopping cart 124a-c shines light into the sensors 132, 134), the signal can be ignored based on an out-of-aisle status of the shopping cart 124a-d.

Another potential source of error may arise from light being improperly detected as it reflects off of a first position indicator 122a, crosses the aisle 104a-d, reflects off a second position indicator 122a on the opposite side, and then is picked up by the sensor 132, 134 on the wrong side of the shopping cart 124a-d. In some examples, crosstalk between the sensors 132, 134 is resolved by controlling the timing when the light source associated with each of the sensors 132, 134 transmits light such that there is no overlap, and any reflected light picked up by the wrong sensor is ignored. In other examples, the light transmitted for detection by the first sensor 132 is modulated at a different frequency than light transmitted for detection by the second sensor 134 to distinguish the origin of the light for each sensor 132, 134. Modulating the frequencies of transmitted light in this manner also eliminates the concern of detecting light transmitted from one of the shopping carts 124a-d passing another one of the shopping carts 124a-d when the shopping carts 124a-d are facing in the same direction. For example, if the light source for each of the sensors 132 on each shopping cart 124a-d is associated with a first frequency and the light source for each of the sensors 134 on each shopping cart 124a-d is associated with a second different frequency, when two shopping carts 124a-d pass each other while facing the same direction, the opposing sensors 132, 134 on each of the shopping carts 124a-d will be facing such that the light transmitted from each shopping cart 124a-d will not correspond to the facing sensor 132, 134 of the other shopping cart 124a-d and, thus, be ignored.

However, if the shopping carts 124a-d pass each other as they move in opposite directions, the sensors 132, 134 of each shopping cart 124a-d will detect the light from each other and incorrectly treat it as a feedback signal from a reflective position indicator 122a. Similarly, stray light reflected off of something (e.g., a product) other than the reflective position indicators 122a while the shopping carts 124a-d are in one of the aisles 104a-d can result in the incorrect detection of a feedback signal. Accordingly, in some examples, each feedback signal is compared in the context of the surrounding feedback signals that have been detected and the position information that has been determined. For example, when shopping carts 124a-d are not within an aisle as determined by detecting an entry identification section as described above, such unexpected signals of detected light are ignored. In some examples, when the shopping carts 124a-d are within an aisle but not within one of the aisle identification sections 136, a stray feedback signal detected by the sensor 132, 134 facing toward the arrays 118 in the illustrated example is ignored because the arrays 118 on the primary side of each of the aisles 104a-d do not include reflective position indicators outside of the aisle identification sections 136. In other examples, the frequency at which the feedback signals are detected is monitored to identify isolated feedback signals that are out of sync with the observed pattern. It can be assumed that shoppers push shopping cart 124a-d at a substantially constant rate (even if different between different shoppers) such that any isolated inconsistency may be flagged as unexpected. For example, if a feedback signal is detected every half second in the span of a ten second period except for one extra feedback signal detected at four and a quarter seconds, the extra feedback signal may be flagged. In some such examples, the flagged signal is ignored when calculating the position of the shopping cart 124a-d as being inadvertently detected (e.g., due to light from a passing shopping cart 124a-d). In other examples, the flagged signal may nevertheless be incorporated into position calculations on the assumption that while the source of the extra feedback signal may not have been from a reflective position indicator 122a, the source may have blocked a reflective indicator 122a in the vicinity of where the extra signal was detected (e.g., the extra signal may be from a passing shopping cart 124a-d but the wheels and/or other portion of the passing shopping cart 124a-d and/or customer pushing the passing shopping cart 124a-d may have blocked the transmission and reflection of light that would have otherwise occurred). Accordingly, the treatment of extra signals in such examples can vary depending upon the particular arrangement of the sensors 132, 134 on the shopping carts 124a-d, the width of each position indicator 122a-b, the speeds at which the shopping carts 124a-d are moving (determined based on the frequency of feedback signals), and so forth. Similar approaches may be implemented when an unexpected feedback signal is detected while one of the shopping carts 124a-d is passing through an aisle identification section 136. In addition to the above, one or more motion sensors, a compass, and/or other position detection devices may be incorporated to provide secondary measurements of speed, distance, direction, etc. to validate position information and/or be used in conjunction with the position data based on the detected feedback signals to determine position information.

Another challenge to calculating position information occurs when a feedback signal is not detected when there should be one, such as when light transmitted to and/or reflected from a light-reflecting position indicator 122a is blocked (e.g., by another shopping cart 124a-d, a product, a floor display, a shopper, etc.). In some examples, smoothing intelligence is used to analyze the feedback signals detected by the sensors 132, 134 over time to reduce or eliminate gaps and/or inconsistencies in collected position information based on position information that is known. Additionally or alternatively, the sequences of the arrays 118, 120 may be arranged to provide redundancy. As is described above, in some examples, the identifier portion 140 of each aisle identification section 136 may include the same sequence of position indicators 122a-b on both sides of the aisle 104a-d as a redundancy measure. In some examples, a similar approach is used on the rest of the position indicators 122a-b of the arrays 118, 120 by alternating reflective and non-reflective position indicators on both sides in a manner that enables the sides to be distinguished as described above in connection with FIG. 1B. In other examples, other arrangements of the position indicators 122a-b may be implemented to provide redundancy to account for circumstances where there is an obstruction on one side of the shopping carts 124a-d blocking a path for light to travel from a light source to the light-reflecting position indicators 122a and/or from the light-reflecting position indicators 122a to the sensors 132, 134.

Additionally, errors can result based on changing and/or misaligned directions of travel of the shopping carts 124a-c along lengths of the aisles 104a-d (e.g., when a shopping cart weaves back and forth in an aisle and/or turns around mid-aisle). In disclosed examples, shopping carts 124a-c are shown travelling in substantially straight paths that substantially parallel the lengths of the aisles 104a-d. In some examples, inaccuracies in measured directions of travel of the shopping carts 124a-d moving along the aisles 104a-d can be reduced or eliminated by making the widths of the position indicators 122a-b sufficiently wide. However, widening position indicators 122a-b may decrease the resolution or precision of the measured distance traveled by the shopping carts 124a-d within each aisle 104a-d. In many retail settings, identifying a shopper within a few feet of each product is sufficiently adequate. Accordingly, in some examples, each position indicator 122a-b is approximately one foot wide. However, the width may be more or less than this according to the particular monitored environment and/or the desired precision in calculating the position of the shopping cart 124a-d. In situations where one of the shopping carts 124a-d turns around in the middle of an aisle 104a-d, the sensors 132, 134 will be able to identify the change in direction by the switch in which of the sensors 132, 134 detects the alternating sequence of position indicators 122a-b (on the secondary side of the aisles 104a-d) and which does not detect any feedback signals due to the non-reflective position indicators 122b (on the primary side). Upon identifying the change of direction, the distance may continue being calculated except that each successive feedback signal detected subtracts from the total distance within the corresponding aisle 104a-d. In this manner, the in-aisle location or position of the shopping cart can be determined. Additionally, in some examples, as one of the shopping carts 124a-d is turned around mid-aisle, one or both of the sensors 132, 134 may detect a rapid series of feedback signals as the field of view of the sensors 132, 134 sweep across the position indicators 122a-b as they arc around to the opposite side of the aisle. In such examples, such a rapid series of feedback signals is ignored when preceded and followed by other data indicating a change in direction. Additionally, in some such examples, the distance traveled by the shopping carts 124a-d may be automatically adjusted based on the average diameter of the circular path followed by the sensors 132, 134 when the shopping carts 124a-d are turned around (which may depend upon the design of the shopping carts 124a-d and/or the location of the sensors 132, 134 on the shopping carts 124a-d).

In some examples, the shopping carts 124a-d are pushed backwards (which may result in an incorrect determination in direction) or are pushed back and forth in place (which may result in the count of feedback signals increasing without a corresponding increase in the distance traveled). In some examples, errors associated with such events, and/or any other errors described above, are avoided or corrected by incorporating benchmarks or waypoints to validate or confirm the location (i.e., distance traveled) and/or direction of movement. In some examples, waypoints are incorporated into the aisle identification sections 136. As described above, in the illustrated example, each aisle 104a-d is identifiable by using information encoded on one side of the identifier portion 140 of the aisle identification sections 136 such that the other side of the identifier portion 140 may include any sequence of position indicators 122a-b. Accordingly, in some examples, the identifier portions 140 of separate aisle identification sections 136 within the same aisle contain different sequences of position indicators 122a-b to identify each of the separate aisle identification sections 136. For example, the aisle 104c illustrated in FIG. 1E includes three aisle identification sections 136. In the illustrated example, the identifier portion 140 of the array 120 in each of the aisle identification sections 136 contains three light-reflecting position indicators 122a to identify the aisle 104c as corresponding to aisle three. However, each identifier portion 140 of each aisle identification section 136 of the array 118 varies from the other identifier portions 140 of the other aisle identification sections 136 of the array 118. In particular, in the illustrated example, the identifier portion 140 where the shopping cart 124d is located contains a single light-reflecting position indicator 122a indicating that this is the first aisle identification section 136 of the aisle 104c (beginning at the end of the aisle 104c nearest the shopping cart 124d). In a similar manner, the second (middle) and third aisle identification sections 136 are identified with two and three reflective position indicators 122a respectively in each of the corresponding identifier portions 140, thereby distinguishing each of the aisle identification sections 136 within the aisle 104c.

In some examples, the separate aisle identification sections 136 within the same aisle are at known locations along the aisle (e.g., at each end and at the middle of the aisle as shown in FIG. 1E) such that by identifying a particular aisle identification section 136, the distance within the corresponding aisle can be determined independently of the calculated distance travelled based on a count of the position indicators 122a-b. In some examples, the aisle identification sections 136 are positioned at known ratio distances along each aisle 104a-d (e.g., ¼ distance, ⅕ distance, 2/4 distance, etc.) irrespective of the aisle length (i.e., longer aisles would have greater spaces between each aisle identification section). In other examples, each aisle identification section 136 may be set at a known distance from adjacent aisle identification sections 136 (e.g., every fifteen feet apart). Additionally or alternatively, the aisle identification sections 136 may be set at a particular distance from both ends of each aisle 104a-d (e.g., ten feet from either end) or from one end (e.g., every 10 feet starting at a reference end). Accordingly, in such examples, the identification of each separate aisle identification section 136 is used to verify or correct the distance traveled within the aisle and/or the direction of travel (based on the order of successively identified aisle identification sections 136).

Additionally or alternatively, in some examples, the position indicators 122a-b of the boundary portions 138 of the aisle identification sections 136 may also be arranged in sequences that assist in verifying and/or correcting the position calculations associated with shopping carts 124a-d. For example, as described above, the boundary portions 138 may be arranged with different patterns (e.g., rotational symmetric, mirror imaged, etc.) such that the detected sequence is different depending upon the direction of travel and/or the orientation of travel (e.g., forwards or backwards) of the shopping carts 124a-d passing by the boundary portions 138.

Although waypoints have been described in connection with the aisle identification sections 136, in other examples, separate waypoint sections are incorporated in the arrays 118, 120 apart from the aisle identification sections 136 and used in accordance with the same techniques described above. Establishing secondary and/or redundant measures in this manner provides discrete points throughout the monitored environment 102 that can be used to verify the positions of each shopping cart 124a-d and/or to correct calculated positions before any substantial period has passed. In some examples, such information is incorporated into the smoothing intelligence used in analyzing the feedback signals on an ongoing basis. Moreover, in some examples, even without the example waypoints, the location meters 126 of the shopping carts 124a-d of the illustrated example automatically reset the calculated position values each time a shopping cart 124a-d leaves one of the aisles 104a-d and begins calculations upon entering another one of the aisles 104a-d. Thus, even if errors occur in calculating the positions of the shopping carts 124a-d, the errors are typically only of momentary duration. As an additional measure, in some examples, errors can be further reduced or eliminated by using additional position detection devices (e.g., a compass, an accelerometer, a gyroscope, and/or other motion sensors, etc.) to confirm and/or validate positions of the shopping carts 104a-d determined using the position indicators 122a-b.

FIG. 2 is a perspective view of a portion of the example monitored environment 102 of FIG. 1A that depicts the example shopping cart 124a alongside an example shelving system 204 holding products 205 of the example monitored environment 102 of FIG. 1A. In the illustrated example, the shopping cart 124a includes sensors 132, 134 attached to the underside of the bottom carriage of the shopping cart 124a on either side. In such examples, the sensors 132, 134 are not in the way of shoppers. The sensors 132, 134 of the illustrated example are substantially aligned with an array 206 (e.g., substantially similar or identical to the arrays 118, 120 of FIGS. 1A-1E) of position indicators 122a-b affixed to a kick plate 208 of the shelving system 204. The sensors 132, 134 of the illustrated example detect sequences of position indicators 122a-b by detecting light reflected (illustrated by dotted arrows) from the position indicators 122a. In some examples, the shopping cart 124a is also provided with light sources to emit light toward the position indicators 122a-b to generate reflections by the position indicators 122a detectable by the sensors 132, 134. Similar configurations can be used for other shopping carts 124b-d of FIG. 1A.

In some examples, the array 206 is on the kick plate 208, as shown, to be substantially out of view of the shoppers. However, in other examples, the array 206 is affixed at a different location on the shelving system 204 and/or on another structure (e.g., wall, ceiling, floor, or any other product display system) extending along each aisle lateral to a shopping cart moving along the aisle, such as on a shelf (at a different height), on the floor, on the ceiling, and/or other structure aligned with the aisle. In such examples, the position sensors 132, 134 are attached to the shopping cart 124a accordingly to face laterally away from the shopping cart 124a and be directed toward the array 206 and corresponding array on the opposing side of the aisle (e.g., the sensors positioned at a different height on the shopping cart, angled forward or backward, and/or angled upward or downward). Furthermore, in some examples, the sensors 132, 134 are not attached to the side of the shopping cart 124a but are centrally or otherwise located while being directed to opposing sides of the shopping cart 124a. In the illustrated example, each sensor 132, 134 is positioned to detect the position indicators 122a-b of either array extending along the aisle depending upon the direction in which the shopping cart 124a is oriented and moving.

Furthermore, as mentioned above, in some examples, each of the position indicators 122a-b has a fixed width that is known such that the distance travelled by the shopping cart 124a can be determined by counting the number of reflective position indicators 122a and multiplying by the known width. In some examples, the fixed width is used for the position indicators 122a-b in the aisle identification section 136. However, in other examples, where the distance traveled along an aisle identification section 136 is calculated based on a known width of the aisle identification section 136 and/or the corresponding boundary portions 138 and/or the identifier portion 140 as mentioned above and shown in FIG. 2, the position indicators 122a-b within the identifier portion 140 of the aisle identification section 136 are narrower. In this manner, as is shown in the illustrated example, an aisle having a relatively high aisle number (or other identifier) can be provided in a relatively isolated location. For example, in FIG. 2, the identifier portion 140 of the aisle identification section of FIG. 2 has twelve light-reflecting position indicators 122a corresponding to aisle number twelve but are placed within a segment of the array 206 that can otherwise accommodate only four separate reflective position indicators 122a having the same width as the other position indicators 122a-b in the array 206 (e.g., a longer width than the position indicators 122a-b in the identifier portion 140). Furthermore, the width of the position indicators 122a-b within the identifier portion 140 of FIG. 2 is provided based on the ease of illustration. The limit on how narrow the position indicators 122a-b can be in the identifier portion 140 depends upon characteristics of the monitored environment 102 and the accuracy of the sensors 132, 134 to distinctly detect each of the reflective position indicators 122a as the shopping cart 124a passes by.

In a similar manner, the widths of the position indicators 122a-b within the boundary portions 138 of the aisle identification section 136 can be set to any suitable width. Since the boundary portions 138 of the illustrated example comprise a series of successive light-reflecting position indicators 122a, the sensors 132, 134 detecting the boundary portions 138 detect a single continuous feedback signal. As such, in some examples, the boundary portions 138 are viewed as a single position indicator. In the illustrated example, the lines distinguishing each of the position indicators 122a of the boundary portions 138 are for purposes of discussion only and are not present in some examples, because the position indicators 122a are part of a unitary surface (e.g., an aisle length sticker, plate, or label) and/or the edges of each position indicator 122a are otherwise indistinguishable by the sensors 132, 134. Furthermore, as described above, for clarity of explanation, long segments of reflective or non-reflective surfaces have been described herein as a series of corresponding successive reflective or non-reflective position indicators 122a-b but could alternatively be referred to as a single position indicator 122a-b of larger width.

In the illustrated example, the shopping cart 124a also includes the location meter 126 that communicates with the sensors 132, 134 via wires 212 and/or any other suitable communication medium to record and analyze the feedback signals detected by the sensors 132, 134. In some examples, the location meter 126 further receives input data (e.g., from a shopper) and/or generates output data (e.g., a map with the position of the shopping cart 124a) via a user interface 214. In the illustrated example, the user interface 214 is in communication with the location meter 126 via a wire 212, and the user interface 214 comprises an output screen 216 and an input device (e.g., the keypad 218). In some examples, the location meter 126, the sensors 132, 134, and the user interface 214 are located within a single compartment attached to the shopping cart 124a. In some examples, the shopping cart 124a includes one or more solar panels to charge a power supply for the location meter 126, sensors 132, 134, and the user interface 214 via the lighting in the store and/or external sunlight if the shopping cart 124a is taken outside.

In other examples, the location meter 126 provides the output data to be rendered via the display screen of a portable handheld device 220 (e.g., a smart phone) carried by the shopper pushing the shopping cart 124a. In some examples, the portable handheld device 220 is used in place of the user interface 214. In other examples, the portable handheld device 220 may be used in addition to the user interface 214. In some examples, the location meter 126 provides the raw values, voltage, or current of the feedback signals to the shopper's portable handheld device 220 to rely on the processing power of the portable device 220 to calculate the position of the shopping cart 124a. In some examples, the location meter 126 communicates with the portable device 220 via a wireless connection. In other examples, the location meter 126 communicates with the portable device 220 via a cord that plugs into an accessory port (e.g., a headphone jack, a data port, etc.) of the portable device 220.

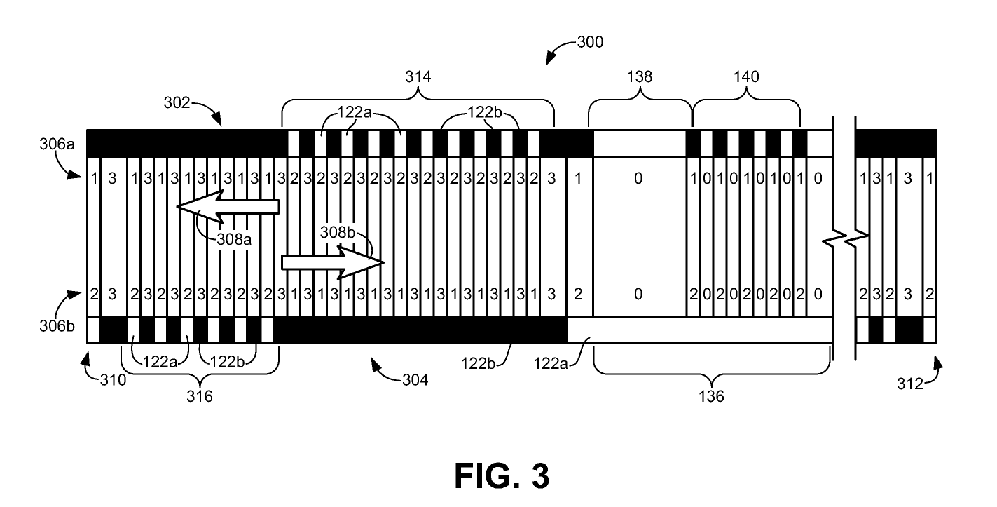

FIG. 3 illustrates an example encoding scheme associated with an example aisle 300 with arrays 302, 304 in accordance with the teachings disclosed herein. In some examples, the aisle 300 and arrays 302, 304 may be used to implement the aisles 104a-d and arrays 118, 120 of the example monitored environment of FIG. 1A. In the illustrated example, the arrays 302, 304 contain light reflecting position indicators 122a and light absorbing position indicators 122b arranged in patterns similar to the arrays 118, 120 described above in connection with FIGS. 1A-1E. Additionally, the illustrated example of FIG. 3 includes a binary encoding pattern 306a corresponding to the decimal representation of a two-bit binary feedback detected from the position indicators 122a-b at each point along the aisle 300 as a corresponding shopping cart 124a-d moves along the aisle in a first direction (represented by the arrow 308a). The illustrated example further includes a binary encoding pattern 306b corresponding to the two-bit binary feedback (in decimal form) detected as the shopping cart 124a-d moves along the aisle 300 in a second direction (represented by the arrow 308b) opposite the first direction 308a.

In the illustrated example, binary encoding patterns 306a-b are based on the reflective position indicators 122a corresponding to the binary digit of 0, while the non-reflective position indicators 122b corresponding to a binary digit of 1. Additionally, in the illustrated example, the left sensor 132 of the shopping carts 124a-d corresponds to the zeroth power of the two-bit binary number and the right sensor 134 corresponds to the first power of the two-bit binary number. Thus, as shown in FIG. 2, when both sensors 132, 134 detect corresponding light-reflecting position indicators 122a, the binary value is 00 (or 0 in decimal notation). When both sensors 132, 134 detect corresponding light-absorbing position indicators 122b, the binary value is 11 (or 3 in decimal notation). Further, the left sensor 132 detecting a reflective position indicator 122a, while the right sensor 134 does not, corresponds to the binary value of 01 (or 1 in decimal notation). Likewise, the right sensor 132 detecting a reflective position indicator 122a, while the left sensor 134 does not, corresponds to the binary value of 10 (or 2 in decimal notation). Using this encoding scheme, in some examples, the sequence of binary values detected as a shopping cart 124a-d moves along the aisle 300 can be analyzed to determine position and/or location information corresponding to a shopping cart 124a-d.

In particular, as shown FIG. 3, at the very ends 310, 312 of the example aisle 300 the array 302 has non-reflective position indicators 122b, whereas the array 304 has reflective position indicators 122a. Accordingly, if a shopping cart 124a-d enters the aisle 300 from the end 312 by moving in the first direction 308a, the first value in the corresponding binary encoding pattern 306a in the illustrated example will be 1. In contrast, if a shopping cart 124a-d enters the aisle 300 at the other end 310 by moving in the second direction 308b, the first value in the corresponding binary encoding pattern 306b in the illustrated example will be 2. Thus, in some examples, the end 310, 312 at which the shopping cart 124a-d enters the aisle 300 is determined based on the first binary encoded value detected within the aisle. In some examples, the end 310, 312 is based on a first series of binary values corresponding to the first series of position indicators 122a-b at each end of the aisle 300. Furthermore, as described above in connection with FIG. 1A, in some examples, multiple aisles contain the same or similar series of position indicators relative to a common reference (e.g., front of a store) such that the first values of the binary encoding pattern 306a-b can identify the direction of travel of the shopping cart 14a-d based on a known direction of orientation of the aisle 300.

In the illustrated example, the aisle 300 includes aisle distance sections 314, 316. Each aisle distance section 314, 316 comprises one array 302, 304 having an alternating pattern of light-reflecting position indicators 122a and light-absorbing position indicators 122b while the other array 302, 304 contains a series of non-reflective position indicators 122b. In the illustrated example, the distance traveled by a shopping cart 124a-d is determined similarly to the examples described above in connection with FIGS. 1A-1E by counting the number of reflective position indicators 122a detected (corresponding to the number of binary values of 1 and/or 2 in the corresponding binary encoding 306a-b). Additionally, in the illustrated example, the direction of travel of a shopping cart 124a-d within each of the aisle distance sections 314, 316 of the aisle 300 may be determined by comparing the resulting binary encoding patterns 306a-b when the shopping cart 124a-d moves in the corresponding direction 308a-b. In particular, as shown within the aisle distance section 314 of the illustrated example, the pattern of the binary encoding pattern 306a corresponding to the first direction 308a alternates between values of 2 and 3. In contrast, the pattern of the binary encoding pattern 306b corresponding to the second direction 308b of the illustrated example alternates between values of 1 and 3. Thus, based on whether the location meter 126 of the shopping carts 124a-d detects binary values of 1 or 2 in the encoding scheme, the direction of travel can be determined.

In the illustrated example, the pattern of values in the binary encoding patterns 306a-b of the aisle distance section 314 are different than the pattern of values in the binary encoding patterns 306a-b of the aisle distance section 316 because the alternating position indicators 122a-b are on opposites sides of the aisle 300 in each of the aisle distance sections 314, 316. Accordingly, based on the method described above, when the location meter 126 detects that a shopping cart 124a-d moves from one of the aisle distance sections 314, 316 to the other aisle distance section 314, 316, the location meter 126 would incorrectly determine that a change of direction of movement of the shopping cart 124a-d has occurred because the sensor 132, 134 detecting the light reflecting pattern would switch from one side of the shopping cart to the other. However, in some examples, to avoid incorrect determinations of the direction of travel, the total length of each aisle distance section 314, 316 is known such that when a shopping cart 124a-d passes the entire length of the aisle distance section 314, 316, the location meter 126 will account for the change in the binary encoding patterns 306a-b. An advantage of alternating the side of the aisle 300 on which the alternating position indicators 122a-b are located is that each transition can be a separate check or waypoint to update the calculated distance of the shopping cart 124a-d within the aisle 300.

For example, as a shopping cart 124a-d is traveling in the second direction 308b along the aisle 300 within the aisle distance section 316, the location meter 126 counts the reflective position indicators 122a of the array 304 (represented as binary value of 2 in the binary encoding pattern 306b) to calculate the distance of the shopping cart 124a-d into the aisle 300. As the shopping cart 124a-d continues in the second direction 308b, the sensors 132, 134 will eventually detect the reflective position indicators 122a of the array 302 as the shopping cart 124a-d enters the aisle distance section 314. In such a situation, if the calculated distance travelled by the shopping cart 124a-d does not correspond to the known length of the aisle distance section 316, it can be assumed that a source of light not corresponding one of the reflective position indicators 122a was detected (if the calculated distance is longer) or that one of the reflective position indicators 122a was blocked (if the calculated distance is shorter). Accordingly, in such examples, the location meter 126 will update the position information of the shopping cart 124a-d based on the known position of the transition point between the aisle distance sections 314, 316.

Additionally, the example aisle 300 of illustrated example of FIG. 3 includes an aisle identification section 136 similar or identical to the aisle identification sections 136 described above that has boundary portions 138 and an identifier portion 140. As shown in the illustrated example, the binary encoding pattern 306a in the identifier portion 140 alternates between 0 and 1 while the binary encoding pattern 306b alternates between 0 and 2. In contrast, as described above, the binary encoding patterns 306a-b alternate between 3 and 1 or 2, depending upon the direction 308a-b. Accordingly, in the illustrated example, the boundary portions 138 of the aisle identification section 136 are omitted because the identifier portion 140 is distinguishable from the aisle distance sections 314, 316 based on whether the binary encoding patterns 306a-b contain a repeating value of 3 (aisle distance sections 314, 316) or 0 (aisle identification section 136).

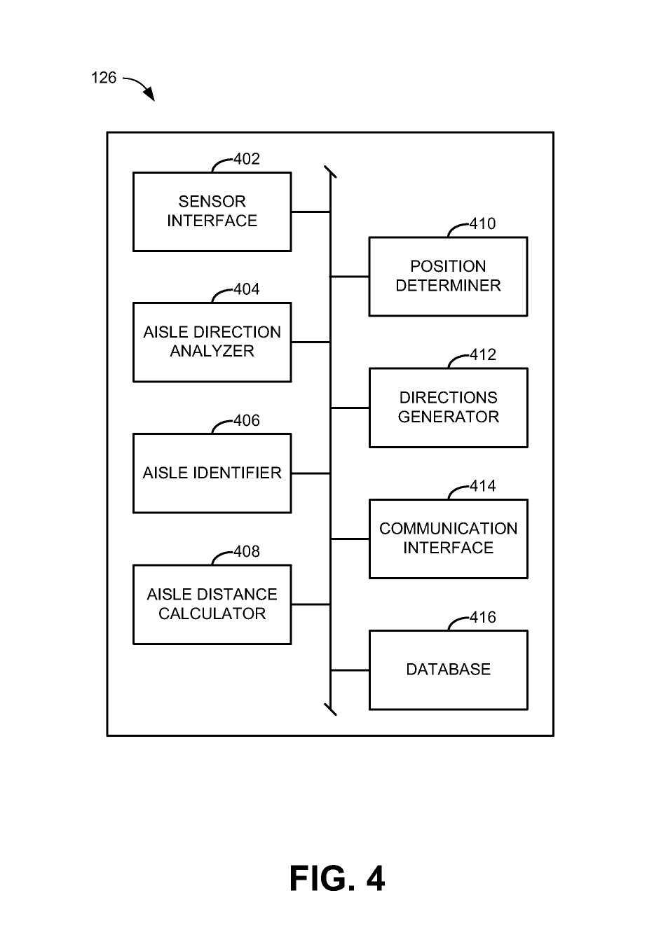

FIG. 4 shows an example configuration of the example location meter 126 of FIGS. 1-2. In the illustrated example of FIG. 4, the example location meter 126 (e.g., an apparatus) includes an example sensor interface 402, an example aisle direction analyzer 404, an example aisle identifier 406, an example aisle distance calculator 408, an example position determiner 410, an example directions generator 412, an example communication interface 414, and an example database 416.

While an example manner of implementing location meter 126 of FIGS. 1-2 is illustrated in FIG. 4, one or more of the elements, processes and/or devices illustrated in FIG. 4 may be combined, divided, re-arranged, omitted, eliminated and/or implemented in any other way. Further, the example sensor interface 402, the example aisle direction analyzer 404, the example aisle identifier 406, the example aisle distance calculator 408, the example position determiner 410, the example directions generator 412, the example communication interface 414, the example database 416, and/or, more generally, the example location meter 126 of FIGS. 1-2 may be implemented by hardware, software, firmware and/or any combination of hardware, software and/or firmware. Thus, for example, any of the example the example sensor interface 402, the example aisle direction analyzer 404, the example aisle identifier 406, the example aisle distance calculator 408, the example position determiner 410, the example directions generator 412, the example communication interface 414, the example database 416, and/or, more generally, the example location meter 126 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, the example sensor interface 402, the example aisle direction analyzer 404, the example aisle identifier 406, the example aisle distance calculator 408, the example position determiner 410, the example directions generator 412, the example communication interface 414, the example database 416 is/are hereby expressly defined to include a tangible computer readable storage device or storage disk such as a memory, a digital versatile disk (DVD), a compact disk (CD), a Blu-ray disk, etc. storing the software and/or firmware. Further still, the example location meter 126 of FIGS. 1-2 may include one or more elements, processes and/or devices in addition to, or instead of, those illustrated in FIG. 4, and/or may include more than one of any or all of the illustrated elements, processes and devices.

Turning in detail to FIG. 4, the example location meter 126 is provided with the example sensor interface 402 to communicate with the sensors 132, 134 of FIGS. 1A-E, and 2 positioned on a shopping cart (e.g., one of the shopping carts 124a-d of FIG. 1A). In the illustrated example, the sensor interface 402 provides the signals to be transmitted by the light source of each sensor and to record the feedback signals detected by each sensor 132, 134. In some examples, the sensor interface 402 also communicates with motion sensing devices (e.g., accelerometer, wheel encoder, etc.) and/or other position sensing devices (e.g., compass). The example location meter 126 is further provided with the example aisle direction analyzer 404 to determine the direction of travel of the shopping cart by comparing the pattern of feedback signals received by each of the sensors on the shopping cart. For example, if one of the sensors 132, 134 detects an alternating pattern of light-reflecting and light-absorbing position indicators while the other sensor does not detect any feedback signals (e.g., a series of successive light-absorbing position indicators), the example aisle direction analyzer 404 determines the direction of travel by associating the side of the cart from which each sensor is directed with a known side of each aisle within a store having an alternating pattern of position indicators. In other examples, the aisle direction analyzer determines the direction of travel based on a different sequence of the position indicators on opposing sides of each aisle.

The location meter 126 of the illustrated example is provided with the example aisle identifier 406 to identify the particular aisle within which the shopping cart is located. In some examples, the example aisle identifier 406 analyzes the feedback signals from both sensors 132, 134 to detect a known boundary portion of an aisle identification section of the arrays extending along each aisle. Once the boundary portion of the aisle identification section is identified, the example aisle identifier 406 analyzes an identifier portion demarcated by the boundary portions of the aisle identification section to determine the corresponding aisle. Additionally, in some example, the aisle identifier 406 keeps track of when the sensors 132, 134 of the shopping cart are within or between aisle identification sections and/or within or between aisles. Furthermore, in some examples, where there are multiple aisle identification sections for each aisle that are separately identified, the example aisle identifier keeps track of which aisle identification section it is in and/or has already passed.

In the illustrated example, the example aisle distance calculator 408 is provided to determine a distance traveled by a shopping cart within an aisle. In some examples, the distance traveled is based on a total number of feedback signals detected and a known width of each position indicator associated with the feedback signals. In some examples, the distance is updated with a known width for each aisle identification section that the shopping cart passes through. Based on the direction determined by the example aisle direction analyzer 404 and/or on the particular aisle identification section identified by the example aisle identifier 406, the aisle distance calculator 408 determines a beginning end of the aisle where the shopping cart started and where the distance traveled is counted from. In some examples, aisle distance calculator 408 updates the calculated distance of travel based on aisle identification sections set at known points (e.g., waypoints) within each aisle such to account for any potential errors in the feedback signals detected.

The example location meter of FIG. 4 is provided with the example position determiner 410 to combine the direction determined by the example aisle direction analyzer 404, the aisle identified by the example aisle identifier 406, and the distance traveled that is calculated by the example aisle distance calculator 408 to unambiguously determine a precise location of the shopping cart within a store. In some examples, the position determiner 410 generates a map displaying the location of the shopping cart to be rendered via a display for a shopper. Accordingly, in some examples, the location meter 126 stores a base map of the store that identifies each corresponding aisle and each end of the aisle for placing an indication of the shopping cart in the proper position within the map of the store. The example location meter 126 of the illustrated example is provided with the example directions generator 412 to generate directions from the position of the shopping cart to a desired location within the store (e.g., the location of a desired product, a desired department, and/or some other location within the store (e.g., the restrooms)). In some examples, the directions generator 412 renders the directions via the display to the shoppers. In some examples, the directions are provided textually. Additionally or alternatively, in some examples, the directions are provided visually by overlaying the directions on the map of the store described above. Accordingly, in some examples, the base map of the store incorporates detailed information regarding the location of items (e.g., products, departments, restrooms, etc.) within the store for reference in generating the map for display with the corresponding directions.

In some examples, the example location meter 126 is provided with the example communication interface 414 to communicate the position of a shopping cart to a display screen (e.g., the output screen 216 of the user interface 214 and/or to a screen of a portable handheld device 220) and/or to receive directions requested by a shopper from an input interface (e.g., the keypad 218 of the user interface 214 and/or the portable handheld device 220). Additionally, the example location meter 126 receives input data (e.g., a request to provide directions to a particular item in the store) from the shopper via the example communication interface 414. In some examples, the example communication interface 414 communicates with a user interface attached to the shopping cart. In other examples, the example communication interface 414 communicates with a portable handheld device (e.g., a smart phone) carried by the shopper.

As shown in FIG. 4, the example location meter 126 is provided with the example database 416 to store the feedback signals detected by the sensors and the characteristics of the arrays and/or the algorithms to interpret the patterns and the resulting calculated values to determine the position of a shopping cart at any location within the store. Furthermore, in some examples, the example database 416 stores a map of the store for display in connection with the position of the shopping cart. In some examples, the database 416 additionally stores a database of products and their locations that are associated with the map to enable the directions generator 412 to generate directions to any items of interest to a shopper.

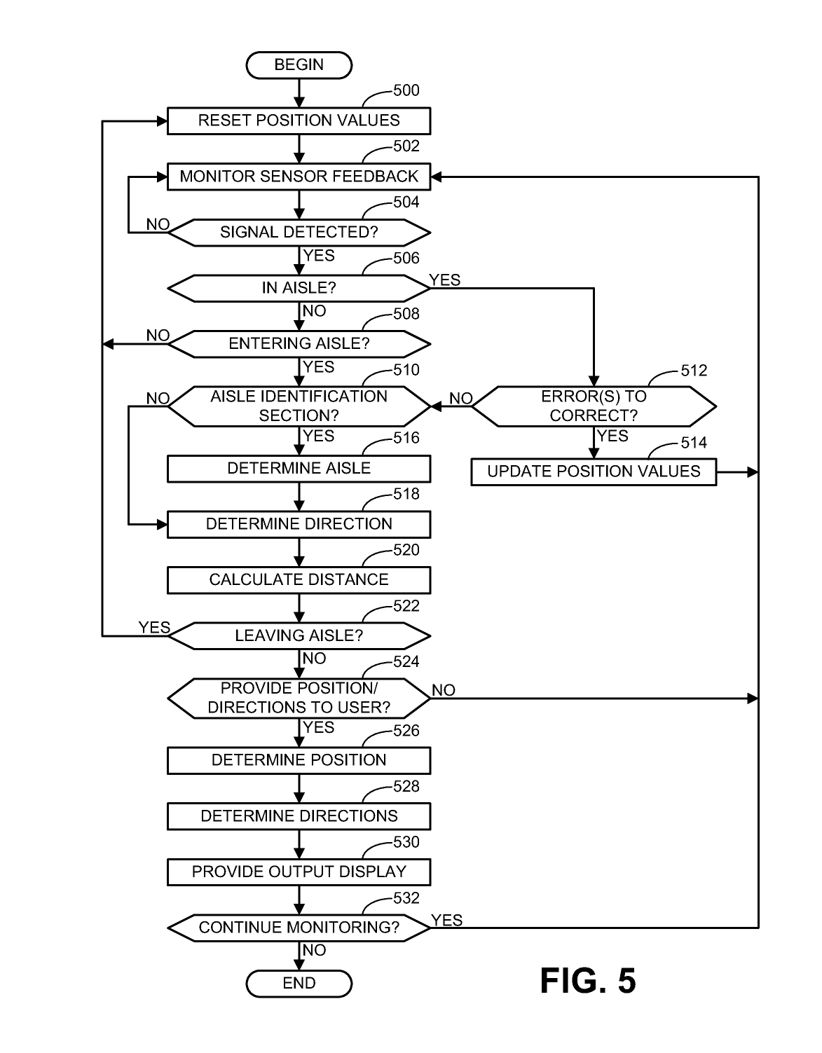

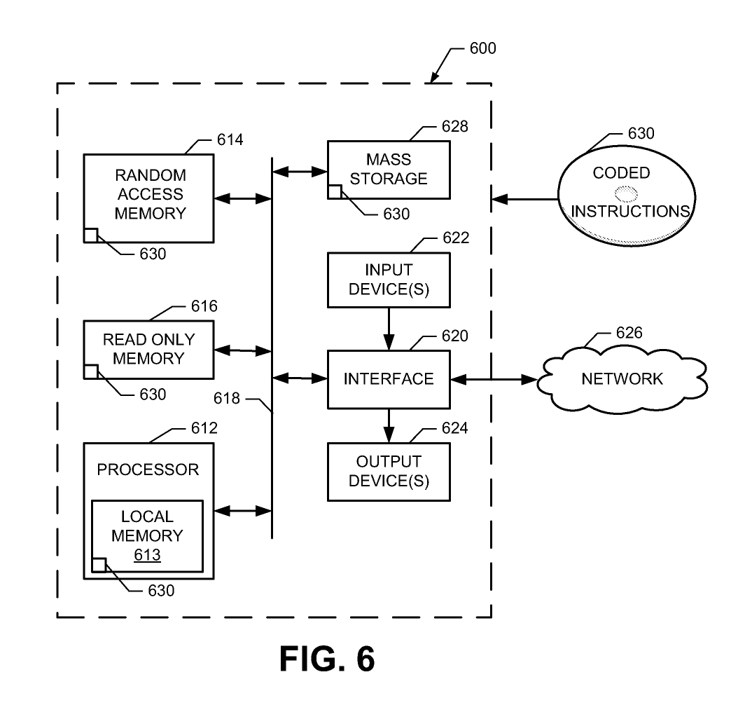

A flowchart representative of example machine readable instructions for implementing the location meter 126 of FIG. 4 is shown in FIG. 5. In this example, the machine readable instructions comprise a program for execution by a processor such as the processor 612 shown in the example processor platform 600 discussed below in connection with FIG. 6. The program may be embodied in software stored on a tangible computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowchart illustrated in FIG. 4, many other methods of implementing the example location meter 126 may alternatively be used. For example, the order of execution of the blocks may be changed, and/or some of the blocks described may be changed, eliminated, or combined.

As mentioned above, the example process of FIG. 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The flowchart of FIG. 5 is representative of example machine readable instructions which may be executed to implement the example apparatus of FIG. 4 to determine in-store positions of shopping carts (e.g., the shopping carts 124a-d of FIG. 1A) in a retail establishment (e.g., the monitored environment 102 of FIG. 1A). The example program begins with the aisle direction analyzer 404, the aisle identifier 406, the aisle distance calculator 408, and/or the position determiner 410 of FIG. 4 resetting their corresponding position values (block 500). The position values correspond to any of the detected signals, the patterns of detected signals, the associated sensor that detected each signal, and/or the resulting calculations from the detected signals defining the position of the associated shopping cart. In some examples, the position values are reset to initialize the associated shopping cart on the assumption the shopping cart begins in a location outside of the aisles and, therefore, will not be detecting any feedback signals. The sensor interface 402 of FIG. 4 monitors sensor feedback (block 502). In some examples, sensors (e.g., the sensors 132, 134 of FIG. 1A) on the shopping cart continuously transmits light out either side of the shopping cart such that when the shopping cart passes through an aisle, the light is reflected back off of one or more light-reflecting position indicators (e.g., the reflective position indicator 122a of FIGS. 1A-1E) in an array of position indicators on each side of the aisle. Accordingly, as the sensor interface 402 monitors the feedback of the sensors (block 502), the sensor interface 404 determines whether a feedback signal is detected (block 504). A feedback signal is detected when one or both of the sensors on the shopping cart detect light (e.g., reflected off of one of the reflective position indicators). In some examples, the feedback signals are represented by a two-bit binary encoding scheme where a binary “0” corresponds to a reflective position indicator and a binary “1” corresponds to a non-reflective position indicator (e.g., the non-reflective position indicator 122b of FIGS. 1A-1E). In other examples, the reflective and non-reflective position indicator

If no feedback signal is detected (block 504), the sensor interface 402 continues to monitor the sensor feedback (block 502). If a feedback signal is detected (block 504), the position determiner 410 determines whether the associated shopping cart is within an aisle (block 506). In some examples, whether the associated shopping cart is within an aisle is based on whether the aisle identifier 406 has identified an aisle status as “in-aisle” or whether the aisle status is “out-of-aisle” or the data values associated with the aisle identifier are otherwise undefined (e.g., after being reset). If the cart is not in an aisle (block 506), the aisle identifier 406 determines whether the shopping cart is entering an aisle (block 508). In some examples, the entry of the shopping cart is assumed based on detecting feedback signals after a threshold period of time without detecting a signal (e.g., during an assumed period outside of any aisle). In other examples, the entry of the shopping cart into an aisle is determined based on the identification of an entry identification section of the arrays of position indicators on either side of an aisle. In some examples, the entry identification section is associated with an aisle identification section (e.g., the aisle identification section 136 of FIG. 1A) located at the extremities of each array of position indicators. If the aisle identifier 406 determines that the shopping cart is not entering an aisle (block 508), in the illustrated example of FIG. 5, control returns to block 500 to reset any values or parameters that may have changed. For example, values and/or parameters may be indicative of an aisle status (e.g., in-aisle or out-of-aisle), a number of position indicators detected, a corresponding distance traveled in the aisle, a direction of travel, an aisle identifier, a number of aisle identification sections 136 detected, and/or any other metric used in determining the position of shopping carts within a monitored environment. In such examples, the values are reset to eliminate the effect of the signal detected because the signal is assumed to be from an unexpected light source (e.g., another shopping cart) as the shopping cart is not within an aisle where the reflective position indicators are located. If the aisle identifier 406 determines that the shopping cart is entering an aisle (block 508), the aisle identifier 406 then determines whether the shopping cart is in an aisle identification section 136 of FIG. 1A (block 510).

Returning to block 506, if the position determiner 410 determines that the shopping cart is already within an aisle, the aisle direction analyzer 404, the aisle identifier 406, the aisle distance calculator 408, and/or the position determiner 410 determines whether there are one or more errors to be corrected from the detected signal (block 512). In some examples, errors are identified based on the detecting of unexpected and/or irregular feedback signals, such as light from another passing shopping cart, a light reflected off of something (e.g., a product) other than one of the position indicators, the shopping cart changing directions mid-aisle, etc.). Depending upon the detected error and/or the surrounding circumstances (e.g., the feedback signals detected immediately before and/or after the unexpected signal) any of the position values may need to be updated. In other examples, while an unexpected feedback signal may be detected, the circumstances may dictate that it can be ignored without affecting the position values. Furthermore, in some examples, the detected signal will not indicate an error and, therefore, will not require any revision of the position values. Accordingly, if the aisle direction analyzer 404, the aisle identifier 406, the aisle distance calculator 408, and/or the position determiner 410 determines that there are error(s) to be corrected (block 512), the corresponding aisle direction analyzer 404, the aisle identifier 406, the aisle distance calculator 408, and/or the position determiner 410 of the example location meter 126 in FIG. 4 updates the corresponding position values (block 514). Once the position values have been updated (block 514), control returns to the sensor interface 402 to continue monitoring the sensor feedback (block 502). If the aisle direction analyzer 404, the aisle identifier 406, the aisle distance calculator 408, and/or the position determiner 410 determines that there are no error(s) to be corrected (block 512), the aisle identifier 406 then determines whether the shopping cart is in an aisle identification section 136 (block 510).

In some examples, the aisle identifier 406 determined whether the shopping cart is within an aisle identification section 136 based on the two-bit binary feedback of corresponding position indicators. In other examples, the aisle identifier 406 determines whether the shopping cart is within an aisle identification section 136 by identifying boundary portions (e.g., the boundary portions 138 of FIG. 1A) of the aisle identification section 136. If the aisle identifier 406 identifies a first boundary portion 138 then the shopping cart is within the aisle identification section 136 until the second boundary portion 138 is identified and passed through. If the aisle identifier 406 determines that the shopping cart is within an aisle identification section 136 (block 510), the aisle identifier 406 determines the corresponding aisle (block 516). For example, the aisle identifier 406 determines the corresponding aisle based on the pattern or sequence of feedback signals detected within a central identifier portion (e.g., the central identifier portion 140 of FIG. 1A) of the aisle identification section 136 as demarcated by the boundary portions 138. The aisle direction analyzer 404 determines the direction of travel the shopping cart (block 518). When the aisle identifier 406 determines that the shopping cart is not within an aisle identification section 136 (block 510), the aisle direction analyzer 404 also determines the direction of the shopping cart (block 518). In some examples, the direction analyzer 404 determines the direction of travel, or orientation, of the shopping cart based on distinguishing the patterns of feedback signals detected on each side of the shopping cart via the sensors 132, 134. The direction analyzer 404 determines which of the feedback signals corresponds to a known array of position indicators on a known (or reference) side of the aisle and associates the corresponding sensor 132, 134 to the known side of the aisle. Further, based on a known side of the shopping cart associated with each sensor 132, 134, the direction analyzer 404 associated the appropriate side of the shopping cart with the known side of the aisle thereby determining the direction in which the shopping cart is facing and travelling. In other examples, the direction of travel may be based on the sequence of the position indicators within the boundary portions 138 and/or the identifier portions 140 of the aisle identification section(s) 136 within the identified aisle.

The aisle distance calculator 408 calculates the distance travelled by the shopping cart (block 520). In some examples, the aisle distance calculator 408 determines the distance traveled based on a total number of position indicators detected multiplied by a known width of each position indicator. In some such examples, the aisle identification sections 136, the corresponding boundary portions 138 and/or the corresponding identifier portion 140 are also arranged with a known width to be added to the total distance calculated as each aisle identification section or portions thereof with a known distance is passed. In some examples, each aisle identification section 136 is placed in a known location along each aisle to serve as a benchmark or waypoint for use by the aisle distance calculator 408 to verify and/or update calculated distances.

In the example of FIG. 5, the aisle identifier 406 determines whether the shopping cart is leaving the aisle (block 522). The aisle identifier 406 determines whether a shopping cart leaving an aisle in a similar manner as described above for a shopping cart entering an aisle. For example, the aisle identifier 406 may determine when a shopping cart leaves an aisle based on detecting a second entry identification section (e.g., at the opposite end of the aisle) and/or based on a change in the feedback signals detected (e.g., no longer detecting feedback signals for a threshold period of time). If the aisle identifier 406 determines that the shopping cart is leaving the aisle (block 522), control returns to block 500 where the position values are reset. If the aisle identifier 406 determines that the shopping cart is not leaving the aisle (block 522), the communication interface 414 determines whether to provide the position of the shopping cart and/or directions to a user (e.g., a shopper pushing the shopping cart) (block 524). In some examples, providing position information and/or directions may be based on receiving a request from a user (e.g., communicated via the communication interface 414). In other examples, at least the position of the shopping cart may be automatically provided via the communication interface 414. In some examples, if insufficient information has been collected to identify the position of the shopping cart (and, therefore, provide directions), then the communication interface 414 will determine not to provide the position information and/or directions to the user. As such, if the communication interface 414 determines not to provide the position of the shopping cart and/or directions to a user (block 524), control returns to block 502 where the sensor interface 402 continues monitoring the sensor feedback.

If the communication interface 414 determines to provide the position of the shopping cart and/or directions to a user (block 524), the position determiner 410 determines the position of the shopping cart (block 526). In the example of FIG. 5, the position determiner determines the position based on the aisle determined by the aisle identifier 406, the direction of travel determined by the aisle direction analyzer 404, and the distance travelled as calculated by the aisle distance calculator 408 (e.g., from a beginning end of the aisle based on the direction of travel). The directions generator 412 then determines directions from the determined position to the location of an item(s) (e.g., product, department, restrooms, etc.) requested by the user (block 528). The location of the item(s) requested by the user may be determined by an item-location database associated with the store that is maintained within the database 416 of FIG. 4.

Once the position is determined (block 526) and the directions are determined (block 528), the communication interface 514 provides an output display (block 530). In some examples, the output display includes a map on which the position of the shopping cart and/or the directions to the requested item(s) is indicated. After outputting the display (block 530), the example process determines whether to continue monitoring the sensor feedback (block 532). If monitoring is to continue, control returns to block 502 where the sensor interface continues monitoring the sensor feedback. If monitoring is not to continue, the example process of FIG. 5 ends.

FIG. 6 is a block diagram of an example processor platform 600 capable of executing the instructions of FIG. 5 to implement the location meter 126 of FIG. 4. The processor platform 600 can be, for example, a server, a personal computer, a mobile device (e.g., a cell phone, a smart phone, a tablet such as an iPad™), a personal digital assistant (PDA), an Internet appliance, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 620 of the illustrated example, thus, typically includes a graphics driver card, a graphics driver chip or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIGS. ______ may be stored in the mass storage device 628, in the volatile memory 614, in the non-volatile memory 616, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
a location meter;
a first sensor to be in communication with the location meter, the first sensor oriented toward a first side of the apparatus to detect:
a first sequence of position indicators in a first array of the position indicators when the location meter is moving along an aisle of a monitored environment in a first direction, or
a second sequence of the position indicators in a second array of the position indicators when the location meter is moving along the aisle in a second direction opposite the first direction, the first and second directions substantially parallel with a length of the aisle; and
a second sensor to be in communication with the location meter, the second sensor oriented toward a second side of the apparatus to detect:
the second sequence of position indicators when the location meter is moving along the aisle in the first direction, or
the first sequence of the position indicators when the location meter is moving along the aisle in the second direction, an in-aisle position of the location meter to be determined based on the first and second sequences of position indicators.

2. (canceled)

3. The apparatus of claim 1, wherein the position indicators include light-reflecting indicators and light-absorbing indicators.

4. The apparatus of claim 3, further comprising:
a first light emitter to emit a first light signal towards:
the first array when the location meter is moving along the aisle in the first direction, or
the second array when the location meter is moving along the aisle in the second direction, the first sensor to detect the first or second sequence of position indicators by detecting first feedback signals corresponding to the first light signal reflected off of the light-reflecting indicators of the corresponding first or second array; and
a second light emitter to emit a second light signal towards:
the second array when the location meter is moving along the aisle in the first direction, or
the first array when the location meter is moving along the aisle in the second direction, the second sensor to detect the first or second sequence of position indicators by detecting second feedback signals corresponding to the second light signal reflected off of the light-reflecting indicators of the corresponding first or second array.

5.-18. (canceled)

19. A method comprising:
detecting a first sequence of position indicators in a first array of position indicators, the first sequence detected by:
a first sensor in communication with a location meter when the location meter is moving in a first direction along an aisle, or
a second sensor in communication with the location meter when the location meter is moving along the aisle in a second direction opposite the first direction;
detecting a second sequence of position indicators in a second array of position indicators, the second sequence detected by:
the first sensor when the location meter is moving in the second direction along the aisle, or
the second sensor when the location meter is moving in the first direction along the aisle; and
determining an in-aisle position of the location meter based on the first and second sequences.

20. The method of claim 19, further comprising:
affixing the first array along a first side of the aisle; and
affixing the second array along a second side of the aisle opposite the first side.

21. The method of claim 19, wherein the position indicators include light-reflecting indicators and light-absorbing indicators.

22. The method of claim 21, further comprising:
emitting, via a first light emitter, a first light signal toward:
the first array when the location meter is moving in the first direction, or
the second array when the location meter is moving in the second direction, wherein the first sensor detects the corresponding first or second sequence of position indicators by detecting a first feedback signal corresponding to the first light signal reflected off of the light-reflecting indicators of the corresponding first or second array; and
emitting, via a second light emitter, a second light signal toward:
the second array when the location meter is moving in the first direction, or
the first array when the location meter is moving in the second direction, wherein the second sensor detects the corresponding first or second sequence of position indicators by detecting a second feedback signal corresponding to the second light signal reflected off of the light-reflecting indicators of the corresponding first or second array.

23. The method of claim 22, further comprising modulating the first light signal at a different frequency than the second light signal.

24. The method of claim 22, wherein the first light beam and the second light beam are generated at mutually exclusive times.

25. The method of claim 21, further comprising determining the in-aisle position of the location meter based on an aisle identifier encoded into the first and second sequences of position indicators, the aisle identifier indicative of an aisle number of the aisle.

26. The method of claim 25, wherein the aisle identifier is encoded within an aisle identification section of the first and second arrays, the aisle identification section comprises an identifier portion to indicate the aisle identifier, and first and second boundary portions to demarcate a beginning and an end of the identifier portion.

27. The method of claim 26, wherein the identifier portion comprises an alternating series of the light-reflecting indicators and the light-absorbing indicators, the number of the light-reflecting indicators in the identifier portion corresponding to the aisle number of the aisle.

28. The method of claim 21, further comprising detecting the in-aisle position of the location meter based on a direction of movement of the location meter with respect to a reference point or a reference direction.

29. The method of claim 22, further comprising:
distinguishing a first pattern of position indicators of the first array from a second pattern of position indicators of the second array; and
determining the direction of movement based on which of the first or second arrays are detected by each of the first and second sensors.

30. The method of claim 23, wherein the first pattern comprises an alternating pattern of the light-reflective indicators and the light-absorbing indicators, and wherein the second pattern comprises a series of successive light-absorbing indicators.

31. The method of claim 21, further comprising determining a distance traveled by the location meter within the aisle based on a number of the light-reflecting indicators detected by the at least one of the first sensor or the second sensor as the location meter moves along the aisle.

32. The method of claim 19, further comprising rendering a display of the in-aisle position of the location meter on a screen.

33. The method of claim 19, wherein the location meter is to be in communication with a separate portable handheld device that determines the in-aisle position of the location meter, the location meter to receive the in-aisle position from the portable handheld device.

34. The method of claim 33, wherein the portable handheld device communicates with the location meter via at least one of a wireless connection or an accessory port on the portable handheld device.

35. The method of claim 19, wherein the location meter is mounted to a shopping cart.

36. The method of claim 19, wherein the monitored environment corresponds to a store or a commercial establishment.

37. A tangible computer readable storage medium comprising instructions, which when executed, cause a machine to at least:
detect a first sequence of position indicators in a first array of position indicators, the first sequence detected by:
a first sensor in communication with a location meter when the location meter is moving in a first direction along an aisle, or
a second sensor in communication with the location meter when the location meter is moving along the aisle in a second direction opposite the first direction;
detect a second sequence of position indicators in a second array of position indicators, the second sequence detected by:
the first sensor when the location meter is moving in the second direction along the aisle, or
the second sensor when the location meter is moving in the first direction along the aisle; and
determine an in-aisle position of the location meter based on the first and second sequences.

38.-54. (canceled)
